(19) United States
(12) Patent Application Publication
(10) Pub. No.: US 2017/0077475 A1
(43) Pub. Date: Mar. 16, 2017

(54) ORGANIC ELECTROLYTE BATTERY

(71) Applicant: JX NIPPON OIL & ENERGY CORPORATION, Tokyo (JP)

(72) Inventors: Atsuo OMARU, Tokyo (JP); Takeshi NISHIZAWA, Tokyo (JP); Hiroaki KONISHI, Tokyo (JP)

(21) Appl. No.: 15/311,439

(22) PCT Filed: May 19, 2015
(86) PCT No.: PCT/JP2015/064286

§ 371 Date: Nov. 15, 2016

(30) Foreign Application Priority Data
May 30, 2014 (JP) 2014-112238

(51) Int. Cl. H01M 2/16; H01M 10/0525

(52) U.S. Cl. CPC H01M 2/162; H01M 2/1686; H01M 10/0525

(57) ABSTRACT

The present invention provides a rechargeable organic electrolyte battery that can be safely used continuously even if abnormality in battery voltage control occurs during use. The rechargeable organic electrolyte battery comprises cathodes, anodes, insulating sheets comprising a resin having no oxygen-containing group electrically insulating the cathodes and anodes from each other, and an organic electrolyte containing reactive ionic species, all contained in a sealed structure, the terminals of the cathodes and anodes being externally pulled out, wherein the insulating sheets are each an assembly of nanoscale filaments and microscale filaments, or a laminate of an assembly of nanoscale filaments and an assembly of microscale filaments.

### TECHNICAL FIELD

The present invention relates to an organic electrolyte battery.

### BACKGROUND ART

Rechargeable batteries (commonly known as LIB) using a Li ion that is mobile energy as reactive species have contributed largely to the development of mobile devices. In the future, they are also sure to contribute to the development of electric-powered vehicles and are believed to exercise their significance as a solution for energy security issues having been concerned since the Great East Japan Earthquake.

While, the applications of the battery are being expanded in such a way, the electrical energy stored therein that will be a source of driving force for a device does not have any problem as long as the battery is used under controlled environmental conditions. Whilst, when some abnormality arise in the controlled environment, in particular when the battery rapidly discharges or the container is broken or damaged due to eternal physical influences that are known to impair the charge and discharge controlling circuit and the safety reliability of the battery, unusual situations occur. That is, it is a problem concerned with dangerousness, and although it has passed over twenty years since the above-mentioned battery have been commercially sold, such a problem has been often seen in the markets.

A battery referred to as 18650 type (diameter: 18 mm, height: 65 mm, cylindrical shape) having been developed for mobile electronic devices has accomplished large volume properties which were initially 900 mAh, about 200 Wh/L and currently enhanced to 3350 mAh, about 700 Wh/L. Whilst, since the beginning, the battery possesses an element of danger in safeness of the cathode material and the electrolyte comprising organic materials, which are far beyond the level of danger possessed by a conventional aqueous electrolyte battery, and it is still vivid in our memories that various accidents caused by misuse of users or defects by manufacturers have been seen quite often. Probably, it is no doubt that situations where many types of devices are driven without cable will continue due to their convenience, but unless dangerousness caused by the devices are taken account, a massive price will have to be paid.

In terms of the safety aspects of a battery, manufacturers have enhanced and accomplished the merchantability to such a level that an electron device with the battery can be used safely by applying various material technologies, design technologies, and manufacturing technologies. Products have been evaluated assuming that they are involved in dangers envisaged with safety tests assuming situations for actual use of batteries that cannot occur under normal circumstances such as mechanical crush (also including accidents) and abnormally high temperature environments (also including heating with heat sources), and the products that clear the hurdles set by the tests have been provided to consumers.

There are various modes for occurrence of dangerousness in the assumption of the dangers, and practical merchantabilities have been established with the aid of technical innovations to deal with the dangers in these modes. However, an increase in the stored electric energy quantity has been continuously demanded, and in order to meet the demand, it is a huge responsibility for manufacturers to not only increase the stored electric quantity but also level up the safety during the use simultaneously.

In one of the above-mentioned modes for occurrence of dangerousness, for example, charging of a battery goes out of control due to breakage of the circuit and the charging is not completed under the original conditions, and the charging voltage might be increase to a voltage which is higher than a predetermined voltage. In this case, this overcharging finally brings about strong decomposition of a cathode material and leads to cause an unsafe state such as fuming or firing.

As examples of improving these events using the above-mentioned material technologies, Japanese Patent Application Laid-Open Publication Nos. 6-338347 and 7-302614 has proposed to avoid the dangerous mode by adding organic molecules having functionality in an electrolyte to cause the organic molecules to be sacrificially reacted instead of causing decomposition of a cathode, resulting in no decomposition thereof. This utilizes properties of the organic molecules having functionality wherein they decompose when a certain electric voltage reaches. The reaction brought about thereupon causes the generation of a reaction product in the electrolyte and electrode surfaces, and as the interior of the battery degraded, the battery cannot be driven.

The above-described dangerousness occurrence mode causes fuming and firing when a circuit controlling charging and discharging goes out of order, and thus in particular the battery is charged at a voltage over the designed allowable voltage, and even though the product is just purchased and when it undergoes this situation, the safety mechanism is actuated so as to stop the operation of the battery and as the result the user would suffers disadvantage. However, in order to reduce the cost, inexpensive circuit parts with low reliability will be used more often, resulting in an increase in breakage and malfunction of the parts and thus the realization of dangerousness/reduction in reliability of a battery happen frequently and will be a serious social problem.

### CITATION LIST

### Patent Literature

Patent Literature 1: Japanese Patent Application Laid-Open Publication No. 6-338347

Patent Literature 2: Japanese Patent Application Laid-Open Publication No. 7-302614

### SUMMARY OF INVENTION

### Technical Problem

In view of the above-described situations, the present invention has an object to provide a battery that can be still safely used continuously even if the circuit breaks.

### Solution to Problem

The present inventors have developed a rechargeable organic electrolyte battery that can be safely used continuously even if abnormality in battery voltage control occurs during use and comprises an organic electrolyte containing reactive ionic species, cathodes, anodes, and ion permeable insulating sheets insulating electrically the cathodes and anodes from each other, accommodated in a sealed structure, with terminals of the cathode and anode being pulled out of the battery.

That is, the present invention relates to an organic electrolyte battery comprising cathodes, anodes, insulating sheets comprising a resin having no oxygen-containing group electrically insulating the cathodes and anodes from each other, and an organic electrolyte containing reactive ionic species, all contained in a sealed structure, the terminals of the cathodes and anodes being externally pulled out, wherein the insulating sheets are each an assembly of nanoscale filaments and microscale filaments, or a laminate of an assembly of nanoscale filaments and an assembly of microscale filaments.

### Advantageous Effect of Invention

The organic electrolyte battery of the present invention will not be out of use because it can be safely used continuously even if the charge and discharge controlling circuit breaks and thus a user does not suffer any disadvantages.

The reason that the above functions of the present invention are exercised is not known. However, it is assumed that a reaction occurs wherein when a circuit breaks down, the balance of Li ions moving in and out of the cathodes and anodes is collapsed, and in particular when exposed to a high voltage, Li ions out of the cathode excessively reach the anode and minute solids such as lithium clusters (metal) are momentarily generated and migrate to the cathodes thereby forming a local battery and immediately return to the cathode. Therefore, for ease of the exercise, the laminated structure of the insulating sheet responsible for the pore structure to migrate or the anode polarization characteristics affecting ease of metal cluster generation must be each within an appropriate range.

### BRIEF DESCRIPTION OF DRAWING

FIG. 1 shows schematically the structure of a battery cell used in examples.

### DESCRIPTION OF EMBODIMENTS

The present invention will be described below.

The organic electrolyte battery of the present invention comprises cathodes, anodes, insulating sheets electrically insulating them from each other, and an organic electrolyte containing reactive ionic species.

The insulating sheet used in the present invention is formed of a resin having no oxygen-containing group and is an ion permeable sheet comprising an assembly of nanoscale filaments and microscale filaments or a laminate of an assembly of nanoscale filaments and an assembly of microscale filaments.

The average diameter of the nanoscale filaments is less than 1000 nm, preferably 100 nm or more and 900 nm or less, more preferably 150 nm or more and 800 nm or less. A too narrow diameter is not preferable because it takes time and cost to form a laminated structure. A too thick diameter is not also preferable because short-circuit between the cathode and anodes happens and the product defectiveness rate is increased.

The average diameter of the microscale filaments is 1 μm or more, preferably 2 μm or more and 50 μm or less, more preferably 3 μm or more and 40 μm or less, more preferably 5 μm or more and 30 μm or less, particularly preferably 10 μm or more and 20 μm or less. A too narrow diameter is not preferable because it takes time and cost to form a laminated structure. A too thick diameter is not also preferable because the resulting sheet is too thick and the volume energy density of the battery is decreased.

When the difference between the outer diameters of the nanoscale filaments and microscale filaments of the insulating sheet is large, it effectively acts on the exercise of the function by defining spaces effective for the above-mentioned cluster formation, and the depth of the spaces is preferably 5 μm or more and 100 μm or less. This can be determined as the maximum value of the surface roughness measured on a sheet surface.

The nanoscale filament and microscale filament are each preferably a filament of thermoplastic resin having no oxygen-containing group. Such thermoplastic resin is particularly preferably a polyolefin, which is chemically stable and unlikely to absorb moisture.

The polyolefin may be a homopolymer of olefins or a copolymer of two or more types of olefins. Specific examples include polyethylene, polypropylene, polybutenes, polyisobutylenes, and polymethylpentene. Particularly preferred are polyethylene and polypropylene.

The insulating sheet used in the present invention may be a sheet wherein filaments forming a laminated structure may be or may not be fixed to each other but is preferably a laminate produced by fixing an assembly of nanoscale filaments and an assembly of microscale filaments.

A method for fixing an assembly of nanoscale filaments and an assembly of microscale filaments may be for example, a method wherein the assemblies are fixed to each other using an adhesive that does not adversely affect the properties of the resulting battery, but in the present invention, a method is preferably employed, in which two or more types of thermoplastic resins with different melting points are used as filaments for the nanoscale filament assembly and microscale filament assembly and heated and compressed at a temperature which is higher or lower than the melting point of the lower melting point resin so that the lower melting point resin is partially melted to form a laminate wherein the nanoscale filament assembly and microscale filament assembly are fixed to each other.

In this case, the difference in melting point between the lower melting point resin and the resin to be fixed (higher melting point resin) used for the thermoplastic resin filaments is preferably 5° C. or higher, more preferably 10° C. or higher, more preferably 30° C. or higher. A difference in melting point of lower than 5° C. is not preferable because when the filaments are fixed, spaces therebetween might be crushed or the resulting laminated structure is forcedly pressed, possibly resulting in a reduced ion permeability.

The ratio of the lower melting point thermoplastic resin filament present in the whole thermoplastic resin filament is preferably 0.2 or greater and 0.6 or less, more preferably 0.3 or greater and 0.5 or less by weight ratio.

Since the laminate to be formed must leave spaces having ion permeability for the resulting sheet, the heating and compressing conditions are adjusted to prevent the lower melting point resin from being melted too much and from clogging the spaces.

When the assemblies are heated and compressed, portions of melted resins form plate-shaped fixed portions, which reduce ion permeability and thus should be minimized. This can be confirmed by calculating the ratio of the area of the fixed portions in the whole area imaged through an SEM or optical microscope observation. Specifically, in the case of using an optical microscope, in the polarizing microscope mode, portions with moire patterns are defined as plate-shaped resin, and the ratio thereof in the image, i.e., the rate of the portions formed into a plate shape can be calculated.

The rate of the portions formed into a plate shape in the insulating sheet is preferably 65% or less, more preferably 55% or less, more preferably 50% or less, particularly preferably 40% or less, most preferably 30% or less of the total area. No particular limitation is imposed on the lower limit. Inevitably, when thermal compression bonding of the lower melting point resin is not carried out, the rate of the portions formed into a plate shape is 0%. A higher rate of the portions formed into a plate shape is not preferable because as ion permeability impaired, reactive ions are hardly to move out of the cathode, and polarization is too large at the anodes, causing Li to be generated in bulk and thus causing the battery characteristics to be degraded.

The nanoscale filament assembly has a thickness of preferably 5 μm or more and 30 μm or less, more preferably 10 μm or more and 20 μm or less.

The microscale filament assembly has a thickness of preferably 5 μm or more, and 80 μm or less, more preferably 10 μm or larger and 60 μm or less, more preferably 20 μm or more and 50 μm or less.

A compression degree is suitably used to define the fixed state. This is a ratio of the thickness of the laminate formed by compressing a filament assembly of an assembly of nanoscale filaments and an assembly of microscale filaments to the total thickness of thereof before being heated and compressed.

That is, it is expressed by “the compression degree=the thickness of the laminate formed by compression/the total thickness of the filament assembly before compression”.

The insulating sheet used in the present invention has a compression degree within the range of preferably 0.1 or greater and 0.65 or less, more preferably 0.2 or greater and 0.6 or less, more preferably 0.4 or greater and 0.5 or less. A too high compression degree is hot preferable because the ion permeability is impaired. A too low compression degree is not also preferable because the volume energy density of the battery is decreased.

The mixed ratio of the nanoscale filaments and the microscale filaments in the insulating sheet is preferably from 90:10 to 10:90, more preferably from 80:20 to 20:80, more preferably from 70:30 to 30:70 by weight ratio. When the ratio of nanoscale filaments is increased, the sheet is too thin and the volume energy density of the battery is decreased. Whilst, when the ratio of the microscale filaments is increased, the sheet will be difficulty to be handled because it is too thick and the strength of the laminated structure is reduced.

The mixed ratio of the nanoscale filaments and microscale filaments in the insulating sheet is obtained by observing the top and bottom surfaces of 10 arbitrarily selected visions of 100 μm square through SEM and averaging the dimensions measured and the number of filaments counted from the image on the screen.

No particular limitation is imposed on the method for manufacturing the nanoscale filaments and microscale filaments and thus any method may be used. For instance, the method may be spunbonding, melt blowing, electrospinning, or drying. Melt blowing and electrospinning are suitable for manufacturing the nanoscale filaments.

For formation of the laminate, a combination of a low melting point resin and a high melting point resin is preferably used as filaments for an assembly of nanoscale filaments and an assembly of microscale filaments. The resins are preferably polyolefin resins such as polyethylene, polypropylene, and polymethylpentene. Any combination from low molecular weight substances and high molecular weight substances is also possible.

In particular, a material containing polyethylene for manufacturing microscale filaments can be used in a process suitable for industrial production and makes it possible to form a thinner insulating sheet. The microscale filaments may be those with a core-in-sheath structure wherein the core is polypropylene (PP) and the sheath is polyethylene (PE). In such a case, the ratio of PE to the total weight of the microscale filaments is preferably from 0.03 to 0.6, more preferably from 0.05 to 0.55, most preferably from 0.1 to 0.5. A less PE is not preferable because fixing of the laminated structure will be insufficient causing the sheet strength to be reduced. A too much PE is not also preferable because the filaments are fixed too much and formation of plate-like portions are facilitated, causing a reduction in the ion permeability of the resulting sheet.

The insulating sheet used in the present invention has a thickness of preferably 5 μm or more, more preferably 10 μm or more, more preferably 15 μm or more and preferably 60 μm or less, more preferably 50 μm or less, more preferably 40 μm or less, particularly preferably 30 μm or less.

A thinner insulating sheet is preferable because in addition to the above-described exercise of the functions, the higher the energy density that is an index of the battery life, the higher the utility value will be. However, when the sheet is too thin, short-circuit between the cathodes and anodes are likely to occur and thus the initial non-defective product rate is decreased. Therefore, the sheet is necessarily of a laminated structure of filaments packed as densely as possible.

In the laminated structure of the filaments, in the case other than where the whole thickness is thin, when the diameters of the pores are large, short-circuit between the cathodes and anodes is likely to occur, resulting in a reduction in the initial non-defectiveness rate of batteries.

The larger the diameter of the pores through the top to bottom surfaces, the more short-circuit is likely to occur. The evaluation of the likelihood can be carried out by permeation of light. It can be evaluated by emitting light from the back surface of a sheet and then measuring the size of bright spots of counting the number thereof.

Ease of the generation of metal clusters migrating from the anodes to the cathodes and ease of receipt of the metal cluster by the cathode are considered as factors affecting the functions of the present invention, and in particular polarization characteristics are important for the anodes.

The polarization characteristics are affected by the external terminals of a battery, the internal resistance that is the total resistance between the cathode and anode terminals, furthermore the electrode resistance contained therein, and moreover the reaction resistance of the electrode materials per se contained therein, and even if the current of the same value flows, phenomenon so-called polarization wherein the higher the resistance, the higher the voltage is becomes significant.

The electrode resistance of an anode is the sum of the resistance of an anode mixture of an anode material such as powdery carbon, a conductive carbon that may be arbitrarily used, and a binder fixing the powdery carbon onto a copper foil, the contact resistance of the anode mixture and a copper foil collector, and the resistance of a tab material such as Ni for applying an electric current from an external circuit to the anode, welded to the copper foil.

The anode material is mainly composed of carbon material, and various materials selected from graphite with a high crystallinity to amorphous carbon with a low crystallinity are available if they can insert and remove lithium ions. They may be mixed as necessary because the conductivity varies depending on the crystallinity.

Although the conductivity varies depending on the type of anode material, it is important to achieve excellent anode polarization characteristics while obtaining good battery properties.

Depending on the usage of a battery in which the stored energy is important or in which the output current is important, the material can be appropriately selected. Desired properties can be obtained by mixing a plurality of materials taking into account of the physical properties, charge and discharge volume and discharge curve.

For the usage where the stored energy is important, the stored quantity of electrical energy is important, and graphite-based materials are suitable for obtaining a high discharge electric voltage. In the case of seeking a long working life of a battery, a conductive agent such as carbon black is preferably added so that the battery is unlikely to be degraded.

For the usage where output current is important, material with a lower resistance associated with letting Li ions in and out is preferable, and amorphous carbon-based materials with interlayers through which Li ions easily move in and out are suitable, but a situation where the stored energy quantity is also important arises, a graphite-based material may be appropriately mixed.

Other than the above-mentioned carbonaceous anode materials, a material containing a metal element such as Si, Sn, and Al forming an allow together with Li, an Si oxide, an Si complex oxide containing Si and a metal element other than Si, an Sn oxide, an Sn complex oxide containing Sn and a metal element other than Sn and Li₄Ti₅O₁₂ may be used alone or in combination with the carbonaceous materials suitably depending on the purposes.

In either of the cases, when the long life is required, a conductive agent is preferably added so that the battery is unlikely to be degraded.

Ion conductivity resistance is also the resistance against which Li ions move in and out and is affected by the void structure of the electrode. Formation of appropriate voids in the anode material enables ions to move easily in and out of the electrode. In order to form such voids, it is necessary to optimize the physical properties of the anode mixture material, mixture composition and compression degree indicating the extent of press shaping.

The surface roughness of the anode is also taken as an example of a factor affecting the anode polarization characteristics relating to the function of the present invention. The maximum value obtained by measuring the surface roughness is particularly desired to be within a defined range. It would appear that this is because upon generation of metal clusters as the result of the anode polarization, clusters are likely to be generated due to the presence of spaces with a certain size wherein ions stay.

The maximum value Ry of the electrode surface roughness of the anode is preferably 2 μm or more and 100 μm or less, more preferably 3 μm or more and 50 μm or less, more preferably 5 μm or larger and 30 μm or less. This is, for example, is obtained by measuring the surface profile using a laser microscope (KEYENCE CORPORATION, VK-8500), followed by calculation with the accompanying analysis software.

For the material used for the anode mixture, in particular the physical properties thereof such as particle size, shape, and hardness affect the surface roughness and thus are needed to be optimally selected.

When the particle diameter is large, the roughness may be large. Whilst, when the particle diameter is small, the roughness may be small. When the particles have a shape of good firing properties, the roughness exhibits a tendency to be small. Natural graphite that is low in hardness is likely to have a small roughness. However, in any of the above cases, the roughness can be optimally controlled with conditions for shaping.

For shaping, the anode mixture fixed to a copper foil collector is processed by cold- or warm-compression, and the conditions therefor can be arbitrarily selected depending on the selection of materials used for the anode and design value of the battery to be demanded.

Even on an electrode surface having been shaped, bulked Li precipitates on micro-sized protrusions, in particular such protrusions with sharpness and may prevent the functions of the present invention from being exercised. Therefore, an anode carbon material with a smooth surface at a micro level is desirous, and in particular beads carbon graphite (mesocarbon microbeads) of graphite material is suitably used. It may be arbitrarily mixed with various materials depending on the requirement of a battery design.

The above-mentioned electrode resistance can be adjusted with a mix ratio of a conductive agent, a binder resin that is non-conductive and an anode material or pressurizing conditions.

The ratio of the conductive agent in the anode mixture is preferably 0.3 percent by mass or more and 20 percent by mass or less, more preferably 0.5 percent by mass or more and 10 percent by mass or less, more preferably 2 percent by mass or more and 8 percent by mass or less.

The conductive agent particles are smaller the main component, and carbon black or the like is suitably used as the conductive agent. Carbon material having been finely crushed may also be used. In this case, graphite, coke, and amorphous carbon regardless whether their electronic and electric properties are good or not may be used.

The binder may be any of fluorine-containing resins, rubbers, acrylic resins, CMC, and PVA, but in particular fluorine-containing resins are suitably used. The ratio of the binder in the anode mixture is preferably 0.5 percent by mass or more and 10 percent by mass or less, more preferably 1 percent by mass or more and 6 percent by mass or less.

Ease of the generation of metal clusters migrating from the anodes to the cathodes and ease of receipt of the metal cluster at the cathodes are considered as factors affecting the functions of the present invention, and in particular ease of the generation of reactive ionic species is important for the cathode.

That is, since reactive ions is emitted smoothly from the cathode, it is necessary to reduce the cathode polarization as much as possible. For this purpose, it is necessary to reduce the resistance of the cathode external terminal, the electrode resistance of the cathode and further the reaction resistance of the electrode material contained therein itself in the battery as much as possible.

The above-mentioned electrode resistance of the cathode includes the contact resistance of a cathode mixture layer of a cathode material itself ranging from a semiconductor to a non-conductor, a conductive agent and a binder resin for bonding to a collecting foil with the collecting foil.

Depending on the type of cathode material, the conductivity varies. Battery properties include volume, output, and safety, and preferred materials include a LiNi-containing material of R3m crystalline structure that is highly conductive, a mixed cathode thereof with a LiMn-containing cathode of spinel crystalline structure that is highly safety, and a mixed cathode of either one of them with a LiCo-containing material of R3m crystalline structure that will increase operating voltage. Some transition metal elements may be substituted with other cations such as Mg, Al and Ti.

In particular, the LiNi-containing material of R3m crystalline structure is preferably used because even if it is exposed to a high electric voltage when the circuit breaks down, the potential of the cathode is unlikely to increase and thus a reduction in the cycle reliability can be suppressed. The LiNi-based material is preferably LiNiCo-based materials, more preferably LiNiMnCo-based materials.

In order to ensure safety, a material containing Mn is preferably mixed with the cathode material, but it is necessary to use it in an optimum amount because it might degrade the reliability.

The electrode resistance can be adjusted with the mix ratio of a conductive agent, a binder resin that is non-conductor and a cathode material or shaping conditions.

The ratio of the conductive agent in the cathode mixture is preferably 0.3 percent by mass or more and 20 percent by mass or less, more preferably 0.5 percent by mass or more and 10 percent by mass or less, more preferably 2 percent by mass or more and 8 percent by mass or less.

The conductive agent particles are smaller the main component, and carbon black or the like is suitably used as the conductive agent. Carbon material having been finely crushed may also be used. In this case, graphite, coke, and amorphous carbon regardless whether their electronic and electric properties are good or not may be used.

The ratio of the conductive agent in the cathode mixture is preferably 0.3 percent by mass or more and 20 percent by mass or less, more preferably 0.5 percent by mass or more and 10 percent by mass or less, more preferably 2 percent by mass or more and 8 percent by mass or less.

The binder may be any of fluororesins, rubbers, and acrylic materials. The ratio of the binder in the cathode mixture is preferably 0.5 percent by mass or more and 8 percent by mass or less, more preferably 1 percent by mass or more and 6 percent by mass or less.

The cathode and anode external terminals of a battery are joined to the electrodes to obtain electron conductivity, which is affected by the method for joining or the joined structure. Generally, a copper foil anode collector and a metal tab such as Ni and an aluminum cathode collector and an Al tab are joined, respectively mainly in the battery, and these elements are sealed with an outer packaging material such as resin or metal and pulled out from the sealed structure as the cathode and anode tabs, resulting in the format of a typical battery.

The method for joining the terminals includes resistance heating and ultrasonic welding, wherein metals are each in a melted state and then bonded to each other. However, in particular in order to obtain a good electron conductivity, it is important to produce highly strong joined surfaces with a shape of irregularities to mesh each other and thus to be hardly peeled off. A coating with insulation properties on the metal surfaces as little as possible is preferable.

In order to decrease the electrode resistance of the cathode, it is particularly necessary to make the insulating coating on the Al surface thin as much as possible.

The type of the insulating coating is an oxide coating such as Al₂O₃, and AlF₃ is also used in the interior of the battery. AlF₃ is a reaction product with an electrolyte solution component and rather is preferably generated in an amount more than a suitable amount for stabilization because it is generated after joining.

The insulating coating on the metal surface has a thickness of preferably 0.1 nm or more and 1000 nm or less, more preferably 0.1 nm or more and 100 nm or less, more preferably 0.1 nm or more and 50 nm or less. This is obtained by carrying out a depth analysis of the coating component while cutting the surface with an Ar ion in a surface analysis such as XPS.

Irregularities of the joined metal surface between the copper foil and nickel tab or the aluminum foil and aluminum tab formed when they are melted have a depth or height of preferably 1 μm or more, more preferably 10 μm or more, more preferably 40 μm or more. This can be confirmed by peeling off the joined surface and observing it through a laser microscope.

The purity of each of the additives is preferably 95% or more, more preferably 98% or more, more preferably 99% or more. When the purity is less than 95%, impurities deteriorating the properties of the battery is possibly contained.

The organic electrolyte is mainly composed of an organic solvent and an electrolyte salt, and as the organic solvent, a high dielectric solvent and a low viscosity solvent are used. The ratio of the high-dielectric solvent contained in the organic electrolyte is preferably 5 to 45 percent by volume, more preferably 10 to 40 percent by volume, more preferably 15 to 38 percent by volume.

The ratio of the low viscosity solvent contained in the organic electrolyte is preferably from 55 to 95 percent by volume, more preferably from 60 to 90 percent by volume, more preferably from 62 to 85 percent by volume.

Examples of the high dielectric solvent include ethylene carbonate, propylene carbonate and also for example, butylene carbonate, γ-butyrolactone, γ-valerolactone, tetrahydrofuran, 1,4-dioxane, N-methyl-2-pyrrolidone, N-methyl-2-oxazolidinone, sulfolane, and 2-methylsulforane.

Examples of the low viscosity solvent include dimethyl carbonate, diethyl carbonate, ethylmethyl carbonate and also for example, methylpropyl carbonate, methylisopropyl carbonate, ethylpropyl carbonate, dipropyl carbonate, methylbutyl carbonate, dibutyl carbonate, dimethoxyethane, methyl acetate, ethyl acetate, propyl acetate, acetic acid isopropyl, butyl acetate, isobutyl acetate, methyl propionate, ethyl propionate, methyl formate, ethyl formate, methyl, butyrate, and methyl isobutyrate.

With the objective of protecting the electrode surface, the following additives are arbitrarily used to improve the repeating characteristics of the battery. Examples of such additives, include vinylene carbonate, vinylethylene carbonate, fluoroethylene carbonate, difluoroethylene carbonate and also, for example, methyltrifluoroethyl carbonate, ditrifluoroethyl carbonate, and ethyltrifluoroethyl carbonate.

An agent that may be combined with the additives may be any of compounds containing, P, N, S and Si and when used, in addition to the advantageous effect of the present invention, effects such as fire retardancy are also obtained.

Any one or more of these additives containing one or more of the agent components in an amount of 0.01 percent by mass to 20 percent by mass, preferably 0.1 percent by mass to 10 percent by mass, more preferably 0.5 percent by mass to 5 percent by mass % enables the advantageous effects of the present invention to be achieved.

When the purity of the additive is 95% or greater, preferably 98% or greater, more preferably 99% or greater, the advantageous effects of the present invention are suitably performed. When the purity is less than 95%, impurities inhibiting the advantageous effects of the present invention are possibly contained, and thus the effects may not be able to obtained.

Examples of the electrolyte salt include inorganic lithium salts such as lithium hexafluorophosphate (LiPF₆), lithium tetrafluoroborate (LiBF₄), lithium hexafluoroarsenate (LiAsF₆), lithium hexafluoroantimonate (LiSbF₆), lithium perchlorate (LiClO₄) and lithium tetrachloroaluminate (LiAlCl₄), and lithium salts of perfluoroalkane sulfonic acid derivatives such as lithium trifluoromethanesulfonate (CF₃SO₃Li), lithium bis(trifluoromethanesulfone)imide [(CF₃SO₂)₂NLi], lithium bis(pentafluoroethanesulfone)imide [(C₂F₃SO₂)₂NLi] and lithium tris(trifluoromethanesulfone)methide [(CF₃SO₂)₃CLi]. The electrolyte salts may be used alone or in combination.

The electrolyte salt is usually contained in a concentration of 0.5 to 3 mol/L, preferably 0.8 to 2 mol/L, more preferably 1.0 to 1.6 mol/L in the organic electrolyte.

The organic electrolyte storage battery of the present invention may contain an electrolyte which turns into gel by inclusion of a polymer compound that swells due to the organic solvent and thus will be a retainer of the organic electrolyte. This is because a higher ion conductivity can be obtained by the polymer compound that swells due to the organic solvent thereby obtaining an excellent charge and discharge efficiency and preventing the liquid leakage from the battery. When the organic electrolyte contains such a polymer compound, the content thereof is preferably set in the range of 0.1 percent by mass or more to 10 percent by mass or less.

When a separator with the both surfaces coated with a polymer compound such as polyvinylidene fluoride is used, the mass ratio of the organic electrolyte and the polymer compound is preferably in the range of 50:1 to 10:1. With this range, a higher charge and discharge efficiency can be obtained.

Examples of the above-mentioned polymer compound include ether-based polymer compounds such as polyvinyl formal, polyethylene oxide and cross-linked bodies containing polyethylene oxide, ester-based polymer compounds such as polymethacrylate, acrylic polymer compounds, polyvinylidene fluoride, and polymers of vinylidene fluoride such as copolymers of vinylidene fluoride and hexafluoropropylene. The polymer compounds may be used alone or in combination. In particular, fluorine polymer compounds such as polyvinylidene fluoride is desirously used from the viewpoint of an effect to prevent swelling during storage at high temperatures.

For the purposes of improving the physical properties such as strength, a binder to which inorganic fine particle are added may be added to the electrode mixture or applied to an electrode surface.

### EXAMPLES

The present invention will be described in more detail with the following examples and comparative examples but is not limited thereto.

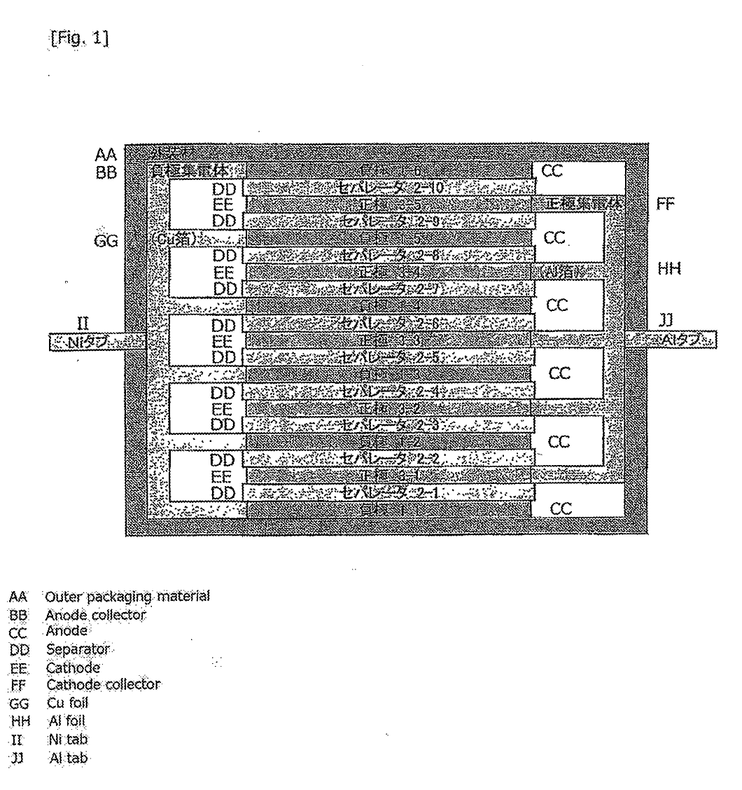

Referring to FIG. 1, the present invention will be described below, but the organic electrolyte battery of the present invention is a type applicable to various types of organic electrolyte batteries such as laminate, button, coin, square, and cylindrical types having a spiral structure. The organic electrolyte battery may be in any size and thus may be large type, small type or thin type.

### Example 1

A cathode was prepared in the following manner. A slurry was prepared by adding and kneading N-methylpyrrolidone (hereinafter abbreviated to NMP) to a mixture of a cathode material of 91 percent by mass of LiNi_{1/3}Mn_{1/3}Co_{1/3}O₂ (average particle diameter 13 μm), a conductive agent of 6 percent by mass of acetylene black, and a binder of 3 percent by mass of poly(vinylidene fluoride) (hereinafter abbreviated to PVDF). The resulting slurry was dripped onto an aluminum collector (purity 99.3%, insulating coating thickness: 10 nm) and formed into a film with an applicator with a micrometer and a machine coater. The resulting film was dried in an oven at a temperature of 110° C. under a nitrogen atmosphere. In the same manner, a film was also formed and dried on the other surface. Thereafter, the film-formed portions on the both surfaces were cut out together into a size of length 1 cm×width 3 cm, and film-formed portions with a width of 1 cm out of the width of 3 cm were peeled off from the both top and bottom surfaces to obtain portions having no film with a size of 1 cm×1 cm on the both surfaces for power collection. Only the film-formed portions were then compressed to be shaped. Five cathodes were prepared in the same manner. The actuation capacity per cathode was 4.0 mAh (2.0 mAh on one surface).

An anode was prepared in the following manner. A slurry was prepared by adding and kneading NMP to a mixture of an active material of 94 percent by mass of artificial graphite, a conductive agent of 1 percent by mass of acetylene black and a binder of 5 percent by mass of PVDF. The resulting slurry was dripped onto an aluminum collector and formed into a film with an applicator with a micrometer and a machine coater. The resulting film was dried in an oven at a temperature of 110° C. under a nitrogen atmosphere. In the same manner, a film is was formed and dried on the other surface. Thereafter, the film-formed portions on the both surfaces were cut out together into a size of length 1 cm×width 3.1 cm, and film-formed portions with a width of 1 cm out of the width of 3.1 cm were peeled off from the both top and bottom surfaces to obtain portions having no film with a size of 1 cm×1 cm on the both surfaces for power collection. Only the film-formed portions were then pressed to be shaped. Three anodes were prepared in the same manner and two anodes with a film only on one surface were also prepared in the same manner. The actuation capacity per anode was 4.0 mAh (2.0 mAh on one surface). The maximum value of the surface roughness of the anode was found to be 18 μm through a laser microscope observation.

A separator (insulating sheet) was produced in the following manner. A fiber assembly (average fiber diameter 700 nm, maximum fiber diameter 2000 nm, minimum fiber diameter 100 nm, thickness 20 μm) of nanoscale filaments made of polypropylene (hereinafter abbreviated to PP) produced by melt blowing and a fiber assembly (average fiber-diameter 12 μm, maximum fiber diameter 20 μm, minimum fiber diameter 5 μm, thickness 27 μm) of core-in-sheath microscale filaments (core: PP, sheath: polyethylene (hereinafter abbreviated to PE), PE content 50 wt %) with a concentric circle dual layer structure produced by spunbonding were pressed to be shaped at a temperature of 130° C. to produce an integrated fiber laminate of the nanoscale filaments and microscale filaments. The fibers were adhered to each other by PE being melted. The laminate after being shaped had a thickness of 24 μm, and the change rate of the total thickness of the nanoscale filaments and microscale filaments after being shaped, i.e., the compress ion degree was 0.5. The rate of the portions formed into a plate shape that is the rate of existence of the melted resin obtained through a polarizing microscope observation was 25%. Thereafter, the laminate was cut to a size of length 1.2 cm×width 2.2 cm as many as necessary.

A battery was assembled in the following manner. First of all, an anode with only one film-formed surface (1-1) is placed, on which film-formed surface a separator (2-1) was placed. A cathode (3-1) was then overlaid thereon such that the portion having no film was oriented in a direction 180° opposite to the portion of having no film of the anode and the film-formed portion did not protrude beyond the anode. A separator (2-2) was placed on the film-formed portion of the cathode (3-1) and then an anode (1-2) with the both surfaces on which films having been formed such that the portions having no film was oriented to a direction 180° opposite to the portions having no film of the cathode, followed by placing a separator (2-3), a cathode (3-2), a separator (2-4), an anode (1-3), a separator (2-5), a cathode (3-3), a separator (2-6), an anode (1-4), a separator (2-7), a cathode (3-4), a separator (2-8), an anode (1-5), a separator (2-9), a cathode (3-5), a separator (2-10), and then an anode with only one film-formed surface (1-6) such that the film-formed portion faced the cathode. The separators were adjusted so that no short-circuit occurs and the whole structure was fixed with an adhesive tape. The portions having no film of the cathodes and anodes were stacked, respectively, and collectors of five cathodes and collectors of six anodes were each integrated to each other with a metal welding apparatus and an aluminum tab and a nickel tab were welded to the cathodes and the anodes, respectively.

The resulting structure was impregnated with a solution produced by dissolving LiPF₆ at a ratio of 1 mole/liter in a solvent that was a mixture of ethylene carbonate (hereinafter abbreviated to EC) as an electrolyte solution and dimethyl carbonate (hereinafter abbreviated to DMC) as a low viscosity solvent at a volume ratio of 3:7. Thereafter, the structure was wrapped with an aluminum laminated film outer package so that no gap was formed and then heated to weld the film to be sealed. The tabs of the cathode and anode were wrapped with a sealant resin to be tightly sealed thereby producing a battery test cell.

This cell was constant-voltage charged at a current density of 0.5 mA/cm² and a constant voltage of 4.2 V and constant-current discharged at a current density of 0.5 mA/cm² and a cut-off voltage of 2.75 V thereby obtaining an initial energy density of 22.4 mWh/cc.

In the same manner, 20 cells were produced and the number of defective products caused by short was counted to obtain the defective product rate. No defective was found.

Next, one of the non-defective cells was repeatedly subjected to a cycle of charge at a voltage of 8 V for a time limit of 10 hours and constant-current discharge at a current density of 0.5 mA/cm² and a cut-off voltage of 2.75 V on the assumption that the control circuit broke down at a current density of 0.5 mA/cm². The ratio of the energy density at the 50th cycle to the initial energy density was 75.3%.

### Example 2

A test cell was prepared in the same manner as Example 1 except that the separator was an integrated fiber laminate (the thickness after shaped=29 μm, the compression degree=0.5, the rate of the portions formed into a plate shape=29%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core, PP, sheath PE, PE content 50 wt %, average fiber diameter 17 μm, maximum fiber diameter 30 μm, minimum fiber diameter 7 μm, thickness 38 μm). No defect was found. The initial energy density was 21.6 mWh/cc, and the ratio of the 50th cycle energy density to the initial energy density was 72.5%.

### Example 3

A test cell was prepared in the same manner as Example 1 except that the separator was an integrated fiber laminate (the thickness after shaped=33 μm, the compression degree=0.5, the rate of the portions formed into a plate shape=34%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath PE, PE content 50 wt %, average fiber diameter 20 μm, maximum fiber diameter 35 μm, minimum fiber diameter 8 μm, thickness 45 μm). No defect was found. The initial energy density was 21.2 mWh/cc, and the ratio of the 50th cycle energy density to the initial energy density vas 71.5%.

### Example 4

A test cell was prepared in the same manner as Example 1 except that the separator was an integrated fiber laminate (the thickness after shaped=47 μm, the compression degree=0, the rate of the portions formed into a plate shape=0%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath PP, PE content 0 wt %, average fiber diameter 12 μm, maximum fiber diameter 20 μm, minimum fiber diameter 5 μm, thickness 27 μm). The defection rate was 20%. The initial energy density of one of the non-defective products was 19.6 mWh/cc, and the ratio of the 50th cycle energy density to the initial energy density was 74.4%.

### Example 5

A test cell was prepared in the same manner as Example 1 except that the separator was an integrated fiber laminate (the thickness after shaped=58 μm, the compression degree=0, the rate of the portions formed into a plate shape=0%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath PP, PE content 0 wt %, average fiber diameter 17 μm, maximum fiber diameter 30 μm, minimum fiber diameter 7 μm, thickness 38 μm). The defection rate was 10%. The initial energy density of one of the non-defective products was 18.5 mWh/cc, and the ratio of the 50th cycle energy density to the initial energy density was 74.4%.

### Example 6

A test cell was prepared in the same manner as Example 1 except that the separator was an integrated fiber laminate (the thickness after shaped=65 μm, the compression degree=0, the rate of the portions formed into a plate shape=0%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath PP, PE content 0 wt %, average fiber diameter 20 μm, maximum fiber diameter 35 μm, minimum fiber diameter 8 μm, thickness 45 μm). The defection rate was 5%. The initial energy density of one of the non-defective products was 17.9 mWh/cc, and the ratio of the 50th cycle energy density to the initial energy density was 73.4%.

### Example 7

A test cell was prepared in the same manner as Example 1 except that the separator was an integrated fiber laminate (the thickness after shaped=16 μm, the compression degree=0.65, the rate of the portions formed into a plate shape=45%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath PE, PE content 70 wt %, average fiber diameter 12 μm, maximum fiber diameter 20 μm, minimum fiber diameter 5 μm, thickness 27 μm). No defect was found. The initial energy density of one of the non-defective products was 21.5 mWh/cc, and the ratio of the 50th cycle energy density to the initial energy density was 64.9%.

### Example 8

A test cell was prepared in the same manner as Example 1 except that separator was an integrated fiber laminate (the thickness after shaped=20 μm, the compression degree=0.65, the rate of the portions formed into a plate shape=49%) of predetermined nanoscale filaments (melt blowing made of PP, average fiber diameter 700 nm, maximum fiber diameter 200 nm, minimum fiber diameter 100 nm, thickness 20 μm) and predetermined microscale filaments (core PP, sheath PE, PE content 70 wt %, average fiber diameter 17 μm, maximum fiber diameter 30 μm, minimum fiber diameter 7 μm, thickness 38 μm). No defect was found. The initial energy density was 18.8 mWh/cc, and the ratio of the 50th cycle energy density to the initial energy density was 62.1%.

### Example 9

A test cell was prepared in the same manner as Example 1 except that the separator was an integrated fiber laminate (the thickness after shaped=23 μm, the compression degree=0.65, the rate of the portions formed into a plate shape=55%) of d predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath PE, PE content 70 wt %, average fiber diameter 20 μm, maximum fiber diameter 35 μm, minimum fiber diameter 8 μm, thickness 45 μm). No defect was found. The initial energy density was 17.1 mWh/cc, and the ratio of the 50th cycle energy density to the initial energy density was 57.4%.

### Example 10

A test cell was prepared in the same manner as Example 1 except that the separator was an integrated fiber laminate (the thickness after shaped=31 μm, the compression degree=0.35, the rate of the portions formed into a plate shape=11%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath PE, PE content 30 wt %, average fiber diameter 12 μm, maximum fiber diameter 20 μm, minimum fiber diameter 5 μm, thickness 27 μm). No defect was found. The initial energy density was 21.4 mWh/cc, and the ratio of the 50th cycle energy density to the initial energy density was 73.4%.

### Example 11

A test cell was prepared in the same manner as Example 1 except that the separator was an integrated fiber laminate (the thickness after shaped=38 μm, the compression degree=0.35, the rate of the portions formed into a plate shape=17%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath PE, PE content 30 wt %, average fiber diameter 17 μm, maximum fiber diameter 30 μm, minimum fiber diameter 7 μm, thickness 38 μm). No defect was found. The initial energy density was 20.6 mWh/cc, and the ratio of the 50th cycle energy density to the initial energy density was 74.4%.

### Example 12

A test cell was prepared in the same manner as Example 1 except that the separator was an integrated fiber laminate (the thickness after shaped=42 μm, the compression degree=0.35, the rate of the portions formed into a plate shape=23%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath PE, PE content 30 wt %, average fiber diameter 20 μm, maximum fiber diameter 35 μm, minimum fiber diameter 8 μm, thickness 45 μm). No defect was found. The initial energy density was 20.1 mWh/cc, and the ratio of the 50th cycle energy density to the in initial energy density was 75.3%.

### Example 13

A test cell was prepared in the same manner as Example 1 except that the separator was an integrated fiber laminate (the thickness after shaped=40 μm, the compression degree=0.15, the rate of the portions formed into a plate shape=5%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath PE, PE content 10 wt %, average fiber diameter 12 μm, maximum fiber diameter 20 μm, minimum fiber diameter 5 μm, thickness 27 μm). No defect was found. The initial energy density was 20.3 mWh/cc, and the ratio of the 50th cycle energy density to the initial energy density was 75.2%.

### Example 14

A test cell was prepared in the same manner as Example 1 except that the separator was an integrated fiber laminate (the thickness after shaped=50 μm, the compression degree=0.15, the rate of the portions formed into a plate shape=7%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath PE, PE content 10 wt %, average filter diameter 17 μm, maximum fiber diameter 30 μm, minimum fiber diameter 7 μm, thickness 38 μm). No defect was found. The initial energy density was 19.3 mWh/cc, and the ratio of the 50th cycle energy density to the initial energy density was 75.3%.

### Example 15

A test cell was prepared in the same manner as Example 1 except that the separator was an integrated fiber laminate (the thickness after shaped=55 μm, the compression degree=0.15, the rate of the portions formed into a plate shape=9%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PP, sheath E, PE content 10 wt %, average fiber diameter 20 μm, maximum fiber diameter 35 μm, minimum fiber diameter 8 μm, thickness 45 μm). No defect was found. The initial energy density was 18.8 mWh/cc, and the ratio of the 50th cycle energy density to the initial energy density vas 74.4%.

### Example 16

A test cell was prepared in the same manner as Example 1 except that the separator was an integrated fiber laminate (the thickness after shaped=21 μm, the compression degree=0.5, the rate of the portions formed into a plate shape=24%) of predetermined nanoscale filaments (melt blowing, made of PP, average fiber diameter 700 nm, maximum fiber diameter 200 nm, minimum fiber diameter 100 nm, thickness 15 μm) and predetermined microscale filaments (core PP, sheath PE, PE content 50 wt %, average fiber diameter 12 μm, maximum fiber diameter 20 μm, minimum fiber diameter 5 μm, thickness 27 μm). No defect was found. The initial energy density was 22.7 mWh/cc, and the ratio of the 50th cycle energy density to the initial energy density was 76.2%.

### Example 17

A test cell was prepared in the same manner as Example 1 except that the separator was an integrated fiber laminate (the thickness after shaped=27 μm, the compression degree=0.5, the rate of the portions formed into a plate shape=28%) of predetermined nanoscale filaments (melt blowing, made of PP, average fiber diameter 700 nm, maximum fiber diameter 200 nm, minimum fiber diameter 100 nm, thickness 15 μm) and predetermined microscale filaments (core PP, sheath PE, PE content 50 wt %, average fiber diameter 17 μm, maximum fiber diameter 30 μm, minimum fiber diameter 7 μm, thickness 38 μm). No defect was found. The initial energy density was 21.9 mWh/cc, and the ratio of the 50th cycle energy density to the initial energy density was 72.5%.

### Example 18

A test cell was prepared in the same manner as Example 1 except that the separator was an integrated fiber laminate (the thickness after shaped=30 μm, the compression degree=0.5, the rate of the portions formed into a plate shape=32%) of predetermined nanoscale filaments (melt blowing, made of PP, average fiber diameter 700 nm, maximum fiber diameter 200 nm, minimum fiber diameter 100 nm, thickness 15 μm) and predetermined microscale filaments (core PP, sheath PE, PE content 50 wt %, average fiber diameter 20 μm, maximum fiber diameter 35 μm, minimum fiber diameter 8 μm, thickness 45 μm). No defect was found. The initial energy density was 21.5 mWh/cc, and the ratio of the 50th cycle energy density to the initial energy density was 71.5%.

### Example 19

A test cell was prepared in the same manner as Example 1 except that the separator was an integrated fiber laminate (the thickness after shaped=19 μm, the compression degree=0.5, the rate of the portions formed into a plate shape=20%) of predetermined nanoscale filaments (melt blowing, made of PP, average fiber diameter 700 nm, maximum fiber diameter 200 nm, minimum fiber diameter 100 nm, thickness 10 μm) and predetermined microscale filaments (core PP, sheath PE, PE content 50 wt %, average fiber diameter 12 μm, maximum fiber diameter 20 μm, minimum fiber diameter 5 μm, thickness 27 μm). No defect was found. The initial energy density was 23.1 mWh/cc, and the ratio of the 50th cycle energy density to the initial energy density was 77.2%.

### Example 20

A test cell was prepared in the same manner as Example 1 except that the separator was an integrated fiber laminate (the thickness after shaped=24 μm, the compression degree=0.5, the rate of the portions formed into a plate shape=21%) of predetermined nanoscale filaments (melt blowing, made of PP, average fiber diameter 700 nm, maximum fiber diameter 200 nm, minimum fiber diameter 100 nm, thickness 10 μm) and predetermined microscale filaments (core PP, sheath PE, PE content 50 wt %, average fiber diameter 17 μm, maximum fiber diameter 30 μm, minimum fiber diameter 7 μm, thickness 38 μm). No defect was found. The initial energy density was 22.3 mWh/cc, and the ratio of the 50th cycle energy density to the initial energy density was 75.3%.

### Example 21

A test cell was prepared in the same manner as Example 1 except that the separator was an integrated fiber laminate (the thickness after shaped=28 μm, the compression degree=0.5, the rate of the portions formed into a plate shape=23%) of predetermined nanoscale filaments (melt blowing, made of PP, average fiber diameter 700 nm, maximum fiber diameter 200 nm, minimum fiber diameter 100 nm, thickness 10 μm) and predetermined microscale filaments (core PP, sheath PE, PE content 50 wt %, average fiber diameter 20 μm, maximum fiber diameter 35 μm, minimum fiber diameter 8 μm, thickness 38 μm). No defect was found. The initial energy density was 21.8 mWh/cc, and the ratio of the 50th cycle energy density to the initial energy density was 75.2%.

### Example 22

A test cell was prepared in the same manner as Example 1 except that the separator was an integrated fiber laminate (the thickness after shaped=23 μm, the compression degree=0.5, the rate of the portions formed into a plate shape=20%) of predetermined nanoscale filaments (melt blowing, made of polymethylpentene (hereinafter abbreviated to PMP), average fiber diameter 750 nm, maximum fiber diameter 2200 nm, minimum fiber diameter 100 nm, thickness 19 μm) and predetermined microscale filaments (core PP, sheath PE, PE content 50 wt %, average fiber diameter 12 μm, maximum fiber diameter 20 μm, minimum fiber diameter 5 μm, thickness 27 μm). No defect was found. The initial energy density was 22.4 mWh/cc, and the ratio of the 50th cycle energy density to the initial energy density was 77.2%.

### Example 23

A test cell was prepared in the same manner as Example 1 except that the separator was a fiber laminate (the thickness after shaped=24 μm, the compression degree=0.5, the rate of the portions formed into a plate shape=20%) of predetermined nanoscale filaments (melt blowing, made of PP, average fiber diameter 700 nm, maximum fiber diameter 200 nm, minimum fiber diameter 100 nm, thickness 20 μm) and predetermined microscale filaments (core PMP, sheath PP, PP content 50 wt %, average fiber diameter 11 μm, maximum fiber diameter 22 μm, minimum fiber diameter 4 μm, thickness 27 μm) integrated by compression at a temperature of 160° C. No defect was found. The initial energy density was 22.3 mWh/cc, and the ratio of the 50th cycle energy density to the initial energy density was 77.3%.

### Example 24

A test cell was prepared in the same manner as Example 1 except that the separator was an integrated fiber laminate (the thickness after shaped=24 μm, the compression degree=0.5, the rate of the portions formed into a plate shape=18%) of predetermined nanoscale filaments (melting method electrospinning, made of PP, average fiber diameter 190 nm, maximum fiber diameter 300 nm, minimum fiber diameter 70 nm, thickness 20 μm) and predetermined microscale filaments (core PP, sheath PE, PE content 50 wt %, average fiber diameter 12 μm, maximum fiber diameter 20 μm, minimum fiber diameter 5 μm, thickness 27 μm). No defect was found. The initial energy density was 23.0 mWh/cc, and the ratio of the 50th cycle energy density to the initial energy density was 75.3%.

### Example 25

A test cell was prepared in the same manner as Example 1 except that the separator was an integrated fiber laminate (the thickness after shaped=29 μm, the compression degree=0.5, the rate of the portions formed into a plate shape=20%) of predetermined nanoscale filaments (melting method electrospinning made of PP, average fiber diameter 190 nm, maximum fiber diameter 300 nm, minimum fiber diameter 70 nm, thickness 20 μm) and predetermined microscale filaments (core PP, sheath PE, PE content 50 wt %, average fiber diameter 17 μm, maximum fiber diameter 30 μm, minimum fiber diameter 7 μm, thickness 38 μm). No defect was found. The initial energy density was 22.3 mWh/cc, and the ratio of the 50th cycle energy density to the initial energy density was 75.4%.

### Example 26

A test cell was prepared in the same manner as Example 1 except that the separator was an integrated fiber laminate (the thickness after shaped=33 μm, the compression degree=0.5, the rate of the portions formed into a plate shape=22%) of predetermined nanoscale filaments (melting method electrospinning, made of PP, average fiber diameter 190 nm, maximum fiber diameter 300 nm, minimum fiber diameter 70 nm, thickness 20 μm) and predetermined microscale filaments (core PP, sheath PE, PE content 50 wt %, average fiber diameter 20 μm, maximum fiber diameter 35 μm, minimum fiber diameter 8 μm, thickness 45 μm). No defect was found. The initial energy density was 21.8 mWh/cc, and the ratio of the 50th cycle energy density to the initial energy density was 75.3%.

### Example 27

A test cell was prepared in the same manner as Example 1 except that the separator was an integrated fiber laminate (the thickness after shaped=21 μm, the compression degree=0.5, the rate of the portions formed into a plate shape=22%) of predetermined nanoscale filaments (melting method electrospinning, made of PP, average fiber diameter 190 nm, maximum fiber diameter 300 nm, minimum fiber diameter 70 nm, thickness 15 μm) and predetermined microscale filaments (core PP, sheath PE, PE content 50 wt %, average fiber diameter 12 μm, maximum fiber diameter 20 μm, minimum fiber diameter 5 μm, thickness 27 μm). No defect was found. The initial energy density was 23.4 mWh/cc, and the ratio of the 50th cycle energy density to the initial energy density was 75.0%.

### Example 28

A test cell was prepared in the same manner as Example 1 except that the separator was an integrated fiber laminate (the thickness after shaped=27 μm, the compression degree=0.5, the rate of the portions formed into a plate shape=23%) of predetermined nanoscale filaments (melting method electrospinning, made of PP, average fiber diameter 190 nm, maximum fiber diameter 300 nm, minimum fiber diameter 70 nm, thickness 15 μm) and predetermined microscale filaments (core PP, sheath PE, PE content 50 wt %, average fiber diameter 17 μm, maximum fiber diameter 30 μm, minimum fiber diameter 7 μm, thickness 38 μm). No defect was found. The initial energy density was 22.6 mWh/cc, and the ratio of the 50th cycle energy density to the initial energy density was 74.9%.

### Example 29

A test cell was prepared in the same manner as Example 1 except that the separator was an integrated fiber laminate (the thickness after shaped=30 μm, the compression degree=0.5, the rate of the portions formed into a plate shape=24%) of predetermined nanoscale filaments (melting method electrospinning, made of PP, average fiber diameter 190 nm, maximum fiber diameter 300 nm, minimum fiber diameter 70 nm, thickness 15 μm) and predetermined microscale filaments (core PP, sheath PE, PE content 50 wt %, average fiber diameter 20 μm, maximum fiber diameter 35 μm, minimum fiber diameter 8 μm, thickness 45 μm). No defect was found. The initial energy density was 22.2 mWh/cc, and the ratio of the 50th cycle energy density to the initial energy density was 75.5%.

### Example 30

A test cell was prepared in the same manner as Example 1 except that the separator was an integrated fiber laminate (the thickness after shaped=19 μm, the compression degree=0.5, the rate of the portions formed into a plate shape=23%) of predetermined nanoscale filaments (melting method electrospinning, made of PP, average fiber diameter 190 nm, maximum fiber diameter 300 nm, minimum fiber diameter 70 nm, thickness 10 μm) and predetermined microscale filaments (core PP, sheath PE, PE content 50 wt %, average fiber diameter 12 μm, maximum fiber diameter 20 μm, minimum fiber diameter 5 μm, thickness 27 μm). No defect was found. The initial energy density was 23.7 mWh/cc, and the ratio of the 50th cycle energy density to the initial energy density was 77.6%.

### Example 31

A test cell was prepared in the same manner as Example 1 except that the separator was an integrated fiber laminate (the thickness after shaped=22 μm, the compression degree=0.5, the rate of the portions formed into a plate shape=24%) of predetermined nanoscale filaments (melting method electrospinning, made of PP, average fiber diameter 190 nm, maximum fiber diameter 300 nm, minimum fiber diameter 70 nm, thickness 10 μm) and predetermined microscale filaments (core PP, sheath PE, PE content 50 wt %, average fiber diameter 17 μm, maximum fiber diameter 30 μm, minimum fiber diameter 7 μm, thickness 38 μm). No defect was found. The initial energy density was 23.2 mWh/cc, and the ratio of the 50th cycle energy density to the initial energy density was 75.2%.

### Example 32

A test cell was prepared in the same manner as Example 1 except that the separator was an integrated fiber laminate (the thickness after shaped=25 μm, the compression degree=0.5, the rate of the portions formed into a plate shape=25%) of predetermined nanoscale filaments (melting method electrospinning, made of PP, average fiber diameter 190 nm, maximum fiber diameter 300 nm, minimum fiber diameter 70 nm, thickness 10 μm) and predetermined microscale filaments (core PP, sheath PE, PE content 50 wt %, average fiber diameter 20 μm, maximum fiber diameter 35 μm, minimum fiber diameter 8 μm, thickness 45 μm). No defect was found. The initial energy density was 22.8 mWh/cc, and the ratio of the 50th cycle energy density to the initial energy density was 74.3%.

### Example 33

A test cell was prepared in the same manner as Example 1 except that the separator was an integrated fiber laminate (the thickness after shaped=24 μm, the compression degree=0.5, the rate of the portions formed into a plate shape=18%) of predetermined nanoscale filaments (melting method electrospinning, made of PP, average fiber diameter 400 nm, maximum fiber diameter 150 0 nm, minimum fiber diameter 100 nm, thickness 20 μm) and predetermined microscale filaments (core PP, sheath PE, PE content 50 wt %, average fiber diameter 12 μm, maximum fiber diameter 20 μm, minimum fiber diameter 5 μm, thickness 27 μm). No defect was found. The initial energy density was 23.0 mWh/cc, and the ratio of the 50th cycle energy density to the initial energy density was 78.1%.

### Example 34

A test cell was prepared in the same manner as Example 1 except that the separator was an integrated fiber laminate (the thickness after shaped=26 μm, the compression degree=0.5, the rate of the portions formed into a plate shape=19%) of predetermined nanoscale filaments (melting method electrospinning, made of PP, average fiber diameter 400 nm, maximum fiber diameter 150 0 nm, minimum fiber diameter 100 nm, thickness 20 μm) and predetermined microscale filaments (core PP, sheath PE, PE content 50 wt %, average fiber diameter 17 μm, maximum fiber diameter 30 μm, minimum fiber diameter 7 μm, thickness 38 μm). No defect was found. The initial energy density was 22.7 mWh/cc, and the ratio of the 50th cycle energy density to the initial energy density was 75.1%.

### Example 35

A test cell was prepared in the same manner as Example 1 except that the separator was an integrated fiber laminate (the thickness after shaped=28 μm, the compression degree=0.5, the rate of the portions formed into a plate shape=20%) of predetermined nanoscale filaments (melting method electrospinning, made of PP, average fiber diameter 400 nm, maximum fiber diameter 150 0 nm, minimum fiber diameter 100 nm, thickness 20 μm) and predetermined microscale filaments (core PP, sheath PE, PE content 50 wt %, average fiber diameter 20 μm, maximum fiber diameter 35 μm, minimum fiber diameter 8 μm, thickness 45 μm). No defect was found. The initial energy density was 22.4 mWh/cc, and the ratio of the 50th cycle energy density to the initial energy density was 76.3%.

### Example 36

A test cell was prepared in the same manner as Example 1 except that the separator was an integrated fiber laminate (the thickness after shaped=21 μm, the compression degree=0.5, the rate of the portions formed into a plate shape=20%) of predetermined nanoscale filaments (melting method electrospinning, made of PP, average fiber diameter 400 nm, maximum, fiber diameter 150 0 nm, minimum fiber diameter 100 nm, thickness 15 μm) and predetermined microscale filaments (core PP, sheath PE, PE content 50 wt %, average fiber diameter 12 μm, maximum fiber diameter 20 μm, minimum fiber diameter 5 μm, thickness 27 μm). No defect was found. The initial energy density was 23.4 mWh/cc, and the ratio of the 50th cycle energy density to the initial energy density was 78.1%.

### Example 37

A test cell was prepared in the same manner as Example 1 except that the separator was an integrated fiber laminate (the thickness after shaped=27 μm, the compression degree=0.5, the rate of the portions formed into a plate shape=21%) of predetermined nanoscale filaments (melting method electrospinning, made of PP, average fiber diameter 400 nm, maximum fiber diameter 150 0 nm, minimum fiber diameter 100 nm, thickness 15 μm) and predetermined microscale filaments (core PP, sheath PE, PE content 50 wt %, average fiber diameter 17 μm, maximum fiber diameter 30 μm, minimum fiber diameter 7 μm, thickness 38 μm). No defect was found. The initial energy density was 22.6 mWh/cc, and the ratio of the 50th cycle energy density to the initial energy density was 75.3%.

### Example 38

A test cell was prepared in the same manner as Example 1 except that the separator was an integrated fiber laminate (the thickness after shaped=30 μm, the compression degree=0.5, the rate of the portions formed into a plate shape=22%) of predetermined nanoscale filaments (melting method electrospinning, made of PP, average fiber diameter 400 nm, maximum fiber diameter 150 0 nm, minimum fiber diameter 100 nm, thickness 15 μm) and predetermined microscale filaments (core PP, sheath PE, PE content 50 wt %, average fiber diameter 20 μm, maximum fiber diameter 35 μm, minimum fiber diameter 8 μm, thickness 45 μm). No defect was found. The initial energy density was 22.2 mWh/cc, and the ratio of the 50th cycle energy density to the initial energy density was 74.4%.

### Example 39

A test cell was prepared in the same manner as Example 1 except that the separator was an integrated fiber laminate (the thickness after shaped=19 μm, the compression degree=0.5, the rate of the portions formed into a plate shape=17%) of predetermined nanoscale filaments (melting method electrospinning, made of PP, average fiber diameter 400 nm, maximum fiber diameter 1500 nm, minimum fiber diameter 100 nm, thickness 10 μm) and predetermined microscale filaments (core PP, sheath PE, PE content 50 wt %, average fiber diameter 12 μm, maximum fiber diameter 20 μm, minimum fiber diameter 5 μm, thickness 27 μm). No defect was found. The initial energy density was 23.7 mWh/cc, and the ratio of the 50th cycle energy density to the initial energy density was 80.0%.

### Example 40

A test cell was prepared in the same manner as Example 1 except that the separator was an integrated fiber laminate (the thickness after shaped=24 μm, the compression degree=0.5, the rate of the portions formed into a plate shape=18%) of predetermined nanoscale filaments (melting method electrospinning, made of PP, average fiber diameter 400 nm, maximum fiber diameter 150 0 nm, minimum fiber diameter 100 nm, thickness 10 μm) and predetermined microscale filaments (core PP, sheath PE, PE content 50 wt %, average fiber diameter 17 μm, maximum fiber diameter 30 μm, minimum fiber diameter 7 μm, thickness 38 μm). No defect was found. The initial energy density was 22.9 mWh/cc, and the ratio of the 50th cycle energy density to the initial energy density was 77.2%.

### Example 41

A test cell was prepared in the same manner as Example 1 except that the separator was an integrated fiber laminate (the thickness after shaped=28 μm, the compression degree=0.5, the rate of the portions formed into a plate shape=19%) of predetermined nanoscale filaments (melting method electrospinning, made of PP, average fiber diameter 400 nm, maximum fiber diameter 1500 nm, minimum fiber diameter 100 nm, thickness 10 μm) and predetermined microscale filaments (core PP, sheath PE, PE content 50 wt %, average fiber diameter 20 μm, maximum fiber diameter 35 μm, minimum fiber diameter 8 μm, thickness 45 μm). No defect was found. The initial energy density was 22.5 mWh/cc, and the ratio of the 50th cycle energy density to the initial energy density was 76.2%.

### Example 42

A test cell was prepared in the same manner as Example 30 except that the cathode material was LiCoO₂ (average particle diameter 5 μm). No defect was found. The initial energy density was 20.0 mWh/cc, and the ratio of the 50th cycle energy density to the initial energy density was 67.8%.

### Example 43

A test cell was prepared in the same manner as Example 30 except that the cathode material was a mixture of LiCoO₂ (average particle diameter 5 μm) and LiNi_{1/3}Mn_{1/3}Co_{1/3}O₂ (average particle diameter 13 μm) at a weight ratio of 50:50. No defect was found. The initial energy density was 22.0 mWh/cc, and the ratio of the 50th cycle energy density to the initial energy density was 73.4%.

### Example 44

A test cell was prepared in the same manner as Example 30 except that the cathode material was a mixture of LiMn₂O₄ (average particle diameter 11 μm) and LiNi_{1/3}Mn_{1/3}Co_{1/3}O₂ (average particle diameter 13 μm) at weight ratio 50:50. No defect was found. The initial energy density was 18.0 mWh/cc, and the ratio of the 50th cycle energy density to the initial energy density was 69.6%.

### Example 45

A test cell was prepared in the same manner as Example 30 except that the cathode material was a mixture of LiNi_{0.85}Co_{0.1}Al_{0.05}O₂ (average particle diameter 5 μm) and LiNi_{1/3}Mn_{1/3}Co_{1/3}O₂ (average particle diameter 13 μm) at a weight ratio of 50:50. No defect was found. The initial energy density was 23.1 mWh/cc, and the ratio of the 50th cycle energy density to the initial energy density was 74.4%.

### Example 46

A test cell was prepared in the same manner as Example 30 except that the pressure for press shaping was changed to produce an anode having a surface roughness maximum value of 100 μm. The defection rate was 10%. The initial energy density was 21.4, mWh/cc, and the ratio of the 50th cycle energy density to the initial energy density was 65.9%.

### Example 47

A test cell was prepared in the same manner as Example 30 except that the pressure for press shaping was changed to produce an anode having a surface roughness maximum value of 70 μm. The defection rate was 0%. The initial energy density was 21.8 mWh/cc, and the ratio of the 50th cycle energy density to the initial energy density was 68.7%.

### Example 48

A test cell was prepared in the same: manner as Example 30 except that the anode material was mesocarbon microbeads (25 μm) and the pressure for press shaping was changed to produce an anode having a surface roughness maximum value of 42 μm. The defection rate was 0%. The initial energy density was 22.2 mWh/cc, and the ratio of the 50th cycle energy density to the initial energy density was 75.3%.

### Example 49

A test cell was prepared in the same manner as Example 30 except that the anode material was natural graphite (15 μm) and the pressure for press shaping was changed to produce an anode having a surface roughness maximum value of 34 μm. The defection rate was 0%. The initial energy density was 22.5 mWh/cc, and the ratio of the 50th cycle energy density to the initial energy density was 77.1%.

### Example 50

A test cell was prepared in the same manner as Example 30 except that the anode material was mesocarbon microbeads (25 μm) and the pressure for press shaping was changed to produce an anode having a surface roughness maximum value of 25 μm. The defection rate was 0%. The initial energy density was 22.8 mWh/cc, and the ratio of the 50th cycle energy density to the initial energy density was 78.1%.

### Example 51

A test cell was prepared in the same manner as Example 30 except that the pressure for press shaping was changed to produce an anode having a surface roughness maximum value of 11 μm. The defection rate was 0%. The initial energy density was 23.1 mWh/cc, and the ratio of the 50th cycle energy density to the initial energy density was 79.1%.

### Example 52

A test cell was prepared in the same manner as Example 30 except that the anode material was mesocarbon microbeads (5 μm) and the pressure for press shaping was changed to produce an anode having a surface roughness maximum value of 5 μm. The defection rate was 0%. The initial energy density was 23.6 mWh/cc, and the ratio of the 50th cycle energy density to the initial energy density was 74.8%.

### Example 53

A test cell was prepared in the same manner as Example 30 except that the anode material was natural graphite (15 μm) and the pressure for press shaping was changed to produce an anode having a surface roughness maximum value of 2 μm. The defection rate was 0%. The initial energy density was 22.2 mWh/cc, and the ratio of the 50th cycle energy density to the initial energy density was 51.8%.

### Example 54

A test cell was prepared in the same manner as Example 30 except that the aluminum collector for the cathode was an aluminum collector with a purity of 99.8%. No defect was found. The initial energy density was 23.1 mWh/cc, and the ratio of the 50th cycle energy density to the initial energy density was 79.1%.

### Example 55

A test cell was prepared in the same manner as Example 30 except that the aluminum collector for the cathode was an aluminum collector with a purity of 99.0%. No defect was found. The initial energy density was 23.1 mWh/cc, and the ratio of the 50th cycle energy density to the initial energy density was 76.2%.

### Example 56

A test cell was prepared in the same manner as Example 30 except that the aluminum collector for the cathode was an aluminum collector with a purity of 98.0%. No defect was found. The initial energy density was 23.1 mWh/cc, and the ratio of the 50th cycle energy density to the initial energy density was 74.4%.

### Example 57

A test cell was prepared in the same manner as Example 30 except that the insulating coating of the aluminum collector for the cathode had a thickness of 0.1 nm. No defect was found. The initial energy density was 23.1 mWh/cc, and the ratio of the 50th cycle energy density to the initial energy density was 78.1%.

### Example 58

A test cell was prepared in the same manner as Example 30 except that the insulating coating of the aluminum collector for the cathode had a thickness of 0.5 nm. No defect was found. The initial energy density was 23.1 mWh/cc, and the ratio of the 50th cycle energy density to the initial energy density was 78.1%.

### Example 59

A test cell was prepared in the same manner as Example 30 except that the insulating coating of the aluminum collector for the cathode had a thickness of 4.0 nm. No defect was found. The initial energy density was 23.1 mWh/cc, and the ratio of the 50th cycle energy density to the initial energy density was 75.3%.

### Example 60

A test cell was prepared in the same manner as Example 30 except that the insulating coating of the aluminum collector for the cathode had a thickness of 17.0 nm. No defect was found. The initial energy density was 23.1 mWh/cc, and the ratio of the 50th cycle energy density to the initial energy density was 66.8%.

### Example 61

A test cell was prepared in the same manner as Example 30 except that the insulating coating of the aluminum collector for the cathode had a thickness of 39.0 nm. No defect was found. Initial energy density was 23.1 mWh/cc, and the ratio of the 50th cycle energy density to the initial energy density was 61.2%.

### Comparative Example 1

A test cell was prepared in the same manner as Example 30 except that the separator was a three-layered fine pore film having a thickness of 32 μm produced by dry uniaxial stretching PE sandwiched between two layers of PP. No defect was found. The initial energy density was 21.3 mWh/cc, and the ratio of the 50th cycle energy density to the initial energy density was 0% (was not able to be discharged because gas was generated during the charging at the first cycle).

### Comparative Example 2

A test cell was prepared in the same manner as Example 30 except that the separator was a fine pore film having a thickness of 25 μm produced by dry uniaxial stretching PP. No defect was found. The initial energy density was 22.2 mWh/cc, and the ratio of the 50th cycle energy density to the initial energy density was 0% (was not able to be discharged because gas was generated during the charging at the first cycle).

### Comparative Example 3

A test cell was prepared in the same manner as Example 30 except that the separator was formed of only nanoscale filaments (melt blowing, made of PP, average fiber diameter 700 nm, maximum fiber diameter 200 nm, minimum fiber diameter 100 nm, thickness 20 μm). The defection rate was 100%, and the cell was not able to be charged or discharged.

### Comparative Example 4

A test cell was prepared in the same manner as Example 30 except that the separator was formed of only nanoscale filaments (melt blowing, made of PP, average fiber diameter 700 nm, maximum fiber diameter 200 nm, minimum fiber diameter 100 nm, thickness 54 μm). The defection rate was 50%. One of the non-defective batteries had an initial energy density of 18.9 mWh/cc, and the ratio of the 50th cycle energy density to the initial energy density was 42.4%.

### Comparative Example 5

A test cell was prepared in the same manner as Example 30 except that the separator was formed of only microscale filaments made of PP (average fiber diameter 17 μm, maximum fiber diameter 30 μm, minimum fiber diameter 7 μm, thickness 38 μm). The defection rate was 80%. One of the non-defective products had an initial energy density of 20.6 mWh/cc, and the ratio of the 50th cycle energy density to the initial energy density was 30.0%.

### Comparative Example 6

A test cell was prepared in the same manner as Example 30 except that the separator was formed of only microscale filaments made of PP (average fiber diameter 17 μm, maximum fiber diameter 30 μm, minimum fiber diameter 7 μm, thickness 62 μm). The defection rate was 20%. One of the non-defective products had an initial energy density of 18.1 mWh/cc, and the ratio of the 50th cycle energy density to the initial energy density was 56.5%.

### Comparative Example 7

A test cell was prepared in the same manner as Example 30 except that the separator was formed of only microscale filaments made of PP (average fiber diameter 17 μm, maximum fiber diameter 30 μm, minimum fiber diameter 7 μm, thickness 100 μm). No defect was found. One of the non-defective products had an initial energy density of 15.3 mWh/cc, and the ratio of the 50th cycle energy density to the initial energy density was 53.7%.

### Comparative Example 8

A test cell was prepared in the same manner as Example 30 except that the separator was formed of only a fiber laminate (the thickness after shaped=60 μm, the compression degree=0.6, the rate of the portions formed into a plate shape=60%) of microscale filaments (core PP, sheath PE, PE content 50 wt %, average fiber diameter 17 μm, maximum fiber diameter 30 μm, minimum fiber diameter 7 μm, thickness 100 μm) produced by press-shaping at a temperature of 130° C. No defect was found. The initial energy density was 18.3 mWh/cc, and the ratio of the 50th cycle energy density to the initial energy density was 37.7%.

### Comparative Example 9

A test cell was prepared in the same manner as Example 30 except that the separator was formed of only nanoscale filaments (melting method electrospinning made of PP, average fiber diameter 190 nm, maximum fiber diameter 300 nm, minimum fiber diameter 70 nm, thickness 20 μm). The defection rate was 10%. One of the non-defective products had an initial energy density of 22.8 mWh/cc, and the ratio of the 50th cycle energy density to the initial energy density was 65.9%.

### Comparative Example 10

A test cell was prepared in the same manner as Example 30 except that the separator was formed of only nanoscale filaments (melting method electrospinning, made of PP, average fiber diameter 190 nm, maximum fiber diameter 300 nm, minimum fiber diameter 70 nm, thickness 15 μm). The defection rate was 30%. One of the non-defective products had an initial energy density of 23.6 mWh/cc, and the ratio of the 50th cycle energy density to the initial energy density was 66.1%.

### Comparative Example 11

A test cell was prepared in the same manner as Example 30 except that the separator was formed of only nanoscale filaments (melting method electrospinning, made of PP, average fiber diameter 190 nm, maximum fiber diameter 300 nm, minimum fiber diameter 70 nm, thickness 10 μm). The defection rate was 100%, and the cell was not able to be charged or discharged.

### Comparative Example 12

A test cell was prepared in the same manner as Example 30 except that the separator was formed of only microscale filaments made of PET (average fiber diameter 15 μm, maximum fiber diameter 27 μm, minimum fiber diameter 8 μm, thickness 100 μm). The defection rate was 5%. One of the non-defective products had an initial energy density of 15.3 mWh/cc, and the ratio of the 50th cycle energy density to the initial energy density was 47.1%.

### Comparative Example 13

A test cell was prepared in the same manner as Example 30 except that the separator was formed of only nanoscale filaments made of PET (electrospinning, average fiber diameter 310 nm, maximum fiber diameter 400 nm, minimum fiber diameter 100 nm thickness 30 μm). The defection rate was 30%. One of the non-defective products had an initial energy density of 21.5 mWh/cc, and the ratio of the 50th cycle energy density to the initial energy density was 51.8%.

### Comparative Example 14

A test cell was prepared in the same manner as Example 30 except that the separator was formed of only microscale filaments made of metharamid (hereinafter referred to as m-AR) (average fiber diameter 10 μm, maximum fiber diameter 15 μm, minimum fiber diameter 3 μm, thickness 60 μm). The defection rate was 5%. One of the non-defective products had an initial energy density of 18.3 mWh/cc, and the ratio of the 50th cycle energy density to the initial energy density was 56.5%.

### Comparative Example 15

A test cell was prepared in the same manner as Example 30 except that the separator was formed of only nanoscale filaments made of m-AR (electrospinning, average fiber diameter 310 nm, maximum fiber diameter 400 nm, minimum fiber diameter 100 nm, thickness 25 μm). The defection rate was 40%. One of the non-defective products had an initial energy density of 22.2 mWh/cc, and the ratio of the 50th cycle energy density to the initial energy density was 57.1%.

### Comparative Example 16

A test cell was prepared in the same manner as Example 30 except that the separator was an integrated fiber laminate (the thickness after shaped=30 μm, the compression degree=0.6, the rate of the portions formed into a plate shape=45%) of nanoscale filaments made of polyethylene terephthalate (PET) (electrospinning, average fiber diameter 310 nm, maximum fiber diameter 400 nm, minimum fiber diameter 100 nm, thickness 23 μm) and predetermined microscale filaments (core PP, sheath PE, PE content 50 wt %, average fiber diameter 12 μm, maximum fiber diameter 20 μm, minimum fiber diameter 5 μm, thickness 27 μm). The defection rate was 5%. One of the non-defective products had an initial energy density of 21.5 mWh/cc, and the ratio of the 50th cycle energy density to the initial energy density was 58.4%.

### Comparative Example 17

A test cell was prepared in the same manner as Example 1 except that the separator was an integrated fiber laminate (the thickness after shaped=28 μm, the compression degree=0.6, the rate of the portions formed into a plate shape=3.5%) of nanoscale filaments made of polyvinyl alcohol (PVA) (electrospinning, average fiber diameter 200 nm, maximum fiber diameter 300 nm, minimum fiber diameter 80 nm, thickness 20 μm) and predetermined microscale filaments (core PP, sheath PE, PE content 50 wt %, average fiber diameter 12 μm, maximum fiber diameter 20 μm, minimum fiber diameter 5 μm, thickness 27 μm). The defection rate was 5%. One of the non-defective products had an initial energy density of 21.7 mWh/cc, and the ratio of the 50th cycle energy density to the initial energy density was 65.9%.

As the results, as shown in the experimental examples of the present invention, the cells thereof can continue the cycle well even though a power-supply voltage (the present experiment: 8 V) beyond the voltage set for charging is applied, assuming a mode where the circuit controlling charge and discharge breaks down.

The structures of the above batteries and evaluation results rate summarized in the following tables.

In the methods for manufacturing the filaments set forth in the tables, MB stands for melt blowing, SB stands for spunbonding, ES stands for electrospinning, and dry stands for dry uniaxial stretching. For the types of cathode materials, NMC stands, for LiNi_{1/3}Mn_{1/3}Co_{1/3}O₂, LCO stands for LiCoO₂, LMO stand for LiMn₂O₄, and NCA stands for LiNi_{0.85}Co_{0.1}Al_{0.05}O₂. For the types of anode materials, AG stands for artificial graphite, MB stands for mesocarbon microbeads, and NG stands for natural graphite.

TABLE 1

| | | | | | | | Microscale filament | | | | | | |
|---|---|---|---|---|---|---|---|---|---|---|---|---|---|
| | Nanoscale filament | | | | | | | | PE | | | | |
| | | | Maxi- | Mini- | Aver- | | | | ratio | Maxi- | Mini- | Aver- | |
| | | | mum | mum | age | | | | Low | mum | mum | age | |
| | Produc- | | dia- | dia- | dia- | Thick- | Produc- | Material | melting | dia- | dia- | dia- | Thick- |
| | tion | | meter | meter | meter | ness | tion | sheath/ | point | meter | meter | meter | ness |
| | method | Material | μm | μm | μm | μm | method | core | ratio | μm | μm | μm | μm |
| Example 1 | MB | PP | 2 | 0.1 | 0.7 | 10 | SB | PE/PP | 0.5 | 20 | 5 | 12 | 27 |
| Example 2 | MB | PP | 2 | 0.1 | 0.7 | 20 | SB | PE/PP | 0.5 | 30 | 7 | 17 | 38 |
| Example 3 | MB | PP | 2 | 0.1 | 0.7 | 20 | SB | PE/PP | 0.5 | 35 | 8 | 20 | 45 |
| Example 4 | MB | PP | 2 | 0.1 | 0.7 | 20 | SB | PP/PP | 0 | 20 | 5 | 12 | 27 |
| Example 5 | MB | PP | 2 | 0.1 | 0.7 | 20 | SB | PP/PP | 0 | 30 | 7 | 17 | 38 |
| Example 6 | MB | PP | 2 | 0.1 | 0.7 | 20 | SB | PP/PP | 0 | 35 | 8 | 20 | 45 |
| Example 7 | MB | PP | 2 | 0.1 | 0.7 | 20 | SB | PE/PP | 0.7 | 20 | 5 | 12 | 27 |
| Example 8 | MB | PP | 2 | 0.1 | 0.7 | 20 | SB | PE/PP | 0.7 | 30 | 7 | 17 | 38 |
| Example 9 | MB | PP | 2 | 0.1 | 0.7 | 20 | SB | PE/PP | 0.7 | 35 | 8 | 20 | 45 |
| Example 10 | MB | PP | 2 | 0.1 | 0.7 | 20 | SB | PE/PP | 0.3 | 20 | 5 | 12 | 27 |
| Example 11 | MB | PP | 2 | 0.1 | 0.7 | 20 | SB | PE/PP | 0.3 | 30 | 7 | 17 | 38 |
| Example 12 | MB | PP | 2 | 0.1 | 0.7 | 20 | SB | PE/PP | 0.3 | 35 | 8 | 20 | 45 |
| Example 13 | MB | PP | 2 | 0.1 | 0.7 | 20 | SB | PE/PP | 0.1 | 20 | 5 | 12 | 27 |
| Example 14 | MB | PP | 2 | 0.1 | 0.7 | 20 | SB | PE/PP | 0.1 | 30 | 7 | 17 | 33 |
| Example 15 | MB | PP | 2 | 0.1 | 0.7 | 20 | SB | PE/PP | 0.1 | 25 | 8 | 20 | 45 |
| Example 16 | MB | PP | 2 | 0.1 | 0.7 | 15 | SB | PE/PP | 0.5 | 20 | 5 | 12 | 27 |
| Example 17 | MB | PP | 2 | 0.1 | 0.7 | 15 | SB | PE/PP | 0.5 | 30 | 7 | 17 | 38 |
| Example 18 | MB | PP | 2 | 0.1 | 0.7 | 15 | SB | PE/PP | 0.5 | 35 | 8 | 20 | 45 |
| Example 19 | MB | PP | 2 | 0.1 | 0.7 | 10 | SB | PE/PP | 0.5 | 20 | 5 | 12 | 27 |
| Example 20 | MB | PP | 2 | 0.1 | 0.7 | 10 | SB | PE/PP | 0.5 | 30 | 7 | 17 | 38 |
| Example 21 | MB | PP | 2 | 0.1 | 0.7 | 10 | SB | PE/PP | 0.5 | 35 | 8 | 20 | 45 |
| Example 22 | MB | PMP | 2.2 | 0.1 | 0.75 | 10 | SB | PE/PP | 0.5 | 20 | 5 | 12 | 27 |
| Example 23 | MB | PP | 2 | 0.1 | 0.7 | 20 | SB | PE/PP | 0.5 | 22 | 4 | 11 | 27 |
| Example 24 | Melt ES | PP | 0.3 | 0.07 | 0.19 | 20 | SB | PE/PP | 0.5 | 20 | 5 | 12 | 27 |
| Example 25 | Melt ES | PP | 0.3 | 0.07 | 0.17 | 20 | SB | PE/PP | 0.5 | 30 | 7 | 17 | 38 |
| Example 26 | Melt ES | PP | 0.3 | 0.07 | 0.19 | 20 | SB | PE/PP | 0.5 | 35 | 8 | 20 | 45 |
| Example 27 | Melt ES | PP | 0.3 | 0.07 | 0.19 | 15 | SB | PE/PP | 0.5 | 20 | 5 | 12 | 27 |
| Example 28 | Melt ES | PP | 0.3 | 0.07 | 0.19 | 15 | SB | PE/PP | 0.5 | 30 | 7 | 17 | 38 |
| Example 29 | Melt ES | PP | 0.3 | 0.07 | 0.19 | 15 | SB | PE/PP | 0.5 | 35 | 8 | 20 | 45 |
| Example 30 | Melt ES | PP | 0.3 | 0.07 | 0.19 | 10 | SB | PE/PP | 0.5 | 20 | 5 | 12 | 27 |
| Example 31 | Melt ES | PP | 0.3 | 0.07 | 0.19 | 10 | SB | PE/PP | 0.5 | 30 | 7 | 17 | 38 |
| Example 32 | Melt ES | PP | 0.3 | 0.07 | 0.19 | 10 | SB | PE/PP | 0.5 | 35 | 0 | 20 | 45 |
| Example 33 | Melt ES | PP | 1.5 | 0.1 | 0.4 | 20 | SB | PE/PP | 0.5 | 20 | 5 | 12 | 27 |
| Example 34 | Melt ES | PP | 1.5 | 0.1 | 0.4 | 20 | SB | PE/PP | 0.5 | 30 | 7 | 17 | 38 |
| Example 35 | Melt ES | PP | 1.5 | 0.1 | 0.4 | 20 | SB | PE/PP | 0.5 | 35 | 8 | 20 | 45 |
| Example 36 | Melt ES | PP | 1.5 | 0.1 | 0.4 | 15 | SB | PE/PP | 0.5 | 20 | 5 | 12 | 27 |
| Example 37 | Melt ES | PP | 1.5 | 0.1 | 0.4 | 15 | SB | PE/PP | 0.5 | 30 | 7 | 17 | 38 |
| Example 38 | Melt ES | PP | 1.5 | 0.1 | 0.4 | 15 | SB | PE/PP | 0.5 | 35 | 8 | 20 | 45 |
| Example 39 | Melt ES | PP | 1.5 | 0.1 | 0.4 | 10 | SB | PE/PP | 0.5 | 20 | 5 | 12 | 27 |
| Example 40 | Melt ES | PP | 1.5 | 0.1 | 0.4 | 10 | SB | PE/PP | 0.5 | 30 | 7 | 17 | 38 |
| Example 41 | Melt ES | PP | 1.5 | 0.1 | 0.4 | 10 | SB | PE/PP | 0.5 | 35 | 8 | 20 | 45 |

| | Laminate | | | | | Anodes | | | | | | |
|---|---|---|---|---|---|---|---|---|---|---|---|---|
| | | | | Rate of | | | Surface | Cathode AL | | | Intial | 50 |
| | | | | formed | | | rough- | | Cost | Defec- | energy | cycle |
| | Thick- | Compres- | | into | Cathodes | Mater- | ness | | thick- | tion | density | retaining |
| | ness | sion | Fixed | plate | Material | ial | max. | Purity | ness | rate | mWh/ | rate |
| | μm | degree | or not | % | type | type | volume | % | nm | % | cc | % |
| Example 1 | 24 | 0.5 | fixed | 25 | NMC | AG | 18 | 99.3 | 10 | 0 | 22.4 | 75.3 |
| Example 2 | 29 | 0.5 | fixed | 29 | NMC | AG | 18 | 99.3 | 10 | 0 | 21.6 | 72.5 |
| Example 3 | 33 | 0.5 | fixed | 34 | NMC | AG | 18 | 99.3 | 10 | 0 | 21.2 | 71.5 |
| Example 4 | 47 | 0 | not fixed | 0 | NMC | AG | 18 | 99.3 | 10 | 20 | 19.6 | 74.4 |
| Example 5 | 58 | 0 | not fixed | 0 | NMC | AG | 18 | 99.3 | 10 | 10 | 18.5 | 74.4 |
| Example 6 | 65 | 0 | not fixed | 0 | NMC | AG | 18 | 99.3 | 10 | 5 | 17.9 | 73.4 |
| Example 7 | 16 | 0.65 | fixed | 45 | NMC | AG | 18 | 99.3 | 10 | 0 | 21.5 | 64.9 |
| Example 8 | 20 | 0.65 | fixed | 49 | NMC | AG | 18 | 99.3 | 10 | 0 | 18.8 | 62.1 |
| Example 9 | 23 | 0.65 | fixed | 55 | NMC | AG | 18 | 99.3 | 10 | 0 | 17.1 | 57.4 |
| Example 10 | 31 | 0.35 | fixed | 11 | NMC | AG | 18 | 99.3 | 10 | 0 | 21.4 | 73.4 |
| Example 11 | 38 | 0.35 | fixed | 17 | NMC | AG | 18 | 99.3 | 10 | 0 | 20.6 | 74.4 |
| Example 12 | 42 | 0.35 | fixed | 23 | NMC | AG | 18 | 99.3 | 10 | 0 | 20.1 | 75.3 |
| Example 13 | 40 | 0.15 | fixed | 5 | NMC | AG | 18 | 99.3 | 10 | 0 | 20.3 | 75.2 |
| Example 14 | 50 | 0.15 | fixed | 7 | NMC | AG | 18 | 99.3 | 10 | 0 | 19.3 | 75.3 |
| Example 15 | 55 | 0.15 | fixed | 9 | NMC | AG | 18 | 99.3 | 10 | 0 | 18.8 | 74.4 |
| Example 16 | 21 | 0.5 | fixed | 24 | NMC | AG | 18 | 99.3 | 10 | 0 | 22.7 | 76.2 |
| Example 17 | 27 | 0.5 | fixed | 28 | NMC | AG | 18 | 99.3 | 10 | 0 | 21.9 | 72.5 |
| Example 18 | 30 | 0.5 | fixed | 32 | NMC | AG | 18 | 99.3 | 10 | 0 | 21.5 | 71.5 |
| Example 19 | 19 | 0.5 | fixed | 20 | NMC | AG | 18 | 99.3 | 10 | 0 | 23.1 | 77.2 |
| Example 20 | 24 | 0.5 | fixed | 21 | NMC | AG | 18 | 99.3 | 10 | 0 | 22.3 | 75.3 |
| Example 21 | 28 | 0.5 | fixed | 23 | NMC | AG | 18 | 99.3 | 10 | 0 | 21.8 | 75.2 |
| Example 22 | 23 | 0.5 | fixed | 20 | NMC | AG | 18 | 99.3 | 10 | 0 | 22.4 | 77.2 |
| Example 23 | 24 | 0.5 | fixed | 20 | NMC | AG | 18 | 99.3 | 10 | 0 | 22.3 | 77.3 |
| Example 24 | 24 | 0.5 | fixed | 18 | NMC | AG | 18 | 99.3 | 10 | 0 | 23.0 | 75.3 |
| Example 25 | 29 | 0.5 | fixed | 20 | NMC | AG | 18 | 99.3 | 10 | 0 | 22.3 | 75.4 |
| Example 26 | 33 | 0.5 | fixed | 22 | NMC | AG | 18 | 99.3 | 10 | 0 | 21.8 | 75.3 |
| Example 27 | 21 | 0.5 | fixed | 22 | NMC | AG | 18 | 99.3 | 10 | 0 | 23.4 | 75.0 |
| Example 28 | 27 | 0.5 | fixed | 23 | NMC | AG | 18 | 99.3 | 10 | 0 | 22.6 | 74.9 |
| Example 29 | 30 | 0.5 | fixed | 24 | NMC | AG | 18 | 99.3 | 10 | 0 | 22.2 | 75.5 |
| Example 30 | 19 | 0.5 | fixed | 23 | NMC | AG | 18 | 99.3 | 10 | 0 | 23.7 | 77.6 |
| Example 31 | 22 | 0.5 | fixed | 24 | NMC | AG | 18 | 99.3 | 10 | 0 | 23.2 | 75.2 |
| Example 32 | 25 | 0.5 | fixed | 25 | NMC | AG | 18 | 99.3 | 10 | 0 | 22.8 | 74.3 |
| Example 33 | 24 | 0.5 | fixed | 18 | NMC | AG | 18 | 99.3 | 10 | 0 | 23.0 | 78.1 |
| Example 34 | 26 | 0.5 | fixed | 19 | NMC | AG | 18 | 99.3 | 10 | 0 | 22.7 | 75.1 |
| Example 35 | 28 | 0.5 | fixed | 20 | NMC | AG | 18 | 99.3 | 10 | 0 | 22.4 | 76.3 |
| Example 36 | 21 | 0.5 | fixed | 20 | NMC | AG | 18 | 99.3 | 10 | 0 | 23.4 | 78.1 |
| Example 37 | 27 | 0.5 | fixed | 21 | NMC | AG | 18 | 99.3 | 10 | 0 | 22.6 | 75.3 |
| Example 38 | 30 | 0.5 | fixed | 22 | NMC | AG | 18 | 99.3 | 10 | 0 | 22.2 | 74.4 |
| Example 39 | 19 | 0.5 | fixed | 17 | NMC | AG | 18 | 99.3 | 10 | 0 | 23.7 | 60.0 |
| Example 40 | 24 | 0.5 | fixed | 18 | NMC | AG | 18 | 99.3 | 10 | 0 | 22.9 | 77.2 |
| Example 41 | 28 | 0.5 | fixed | 19 | NMC | AG | 18 | 99.3 | 10 | 0 | 22.5 | 76.2 |

TABLE 2

| | | | | | | | Microscale filament | | | | | | |
|---|---|---|---|---|---|---|---|---|---|---|---|---|---|
| | Nanoscale filament | | | | | | | | PE | | | | |
| | | | Maxi- | Mini- | Aver- | | | | ratio | Maxi- | Mini- | Aver- | |
| | | | mum | mum | age | | | | Low | mum | mum | age | |
| | Produc- | | dia- | dia- | dia- | Thick- | Produc- | Material | melting | dia- | dia- | dia- | Thick- |
| | tion | | meter | meter | meter | ness | tion | sheath/ | point | meter | meter | meter | ness |
| | method | Material | μm | μm | μm | μm | method | core | ratio | μm | μm | μm | μm |
| Example 42 | Melt ES | PP | 0.3 | 0.07 | 0.19 | 10 | SB | PE/PP | 0.5 | 20 | 5 | 12 | 27 |
| Example 43 | Melt ES | PP | 0.3 | 0.07 | 0.19 | 10 | SB | PE/PP | 0.5 | 20 | 5 | 12 | 27 |
| Example 44 | Melt ES | PP | 0.3 | 0.07 | 0.19 | 10 | SB | PE/PP | 0.5 | 20 | 5 | 12 | 27 |
| Example 45 | Melt ES | PP | 0.3 | 0.07 | 0.19 | 10 | SB | PE/PP | 0.5 | 20 | 5 | 12 | 27 |
| Example 46 | Melt ES | PP | 0.3 | 0.07 | 0.19 | 10 | SB | PE/PP | 0.5 | 20 | 5 | 12 | 27 |
| Example 47 | Melt ES | PP | 0.3 | 0.07 | 0.19 | 10 | SB | PE/PP | 0.5 | 20 | 5 | 12 | 27 |
| Example 48 | Melt ES | PP | 0.3 | 0.07 | 0.19 | 10 | SB | PE/PP | 0.5 | 20 | 5 | 12 | 27 |
| Example 49 | Melt ES | PP | 0.3 | 0.07 | 0.19 | 10 | SB | PE/PP | 0.5 | 20 | 5 | 12 | 27 |
| Example 50 | Melt ES | PP | 0.3 | 0.07 | 0.19 | 10 | SB | PE/PP | 0.5 | 20 | 5 | 12 | 27 |
| Example 51 | Melt ES | PP | 0.3 | 0.07 | 0.19 | 10 | SB | PE/PP | 0.5 | 20 | 5 | 12 | 27 |
| Example 52 | Melt ES | PP | 0.3 | 0.07 | 0.19 | 10 | SB | PE/PP | 0.5 | 20 | 5 | 12 | 27 |
| Example 53 | Melt ES | PP | 0.3 | 0.07 | 0.19 | 10 | SB | PE/PP | 0.5 | 20 | 5 | 12 | 27 |
| Example 54 | Melt ES | PP | 0.3 | 0.07 | 0.19 | 10 | SB | PE/PP | 0.5 | 20 | 5 | 12 | 27 |
| Example 55 | Melt ES | PP | 0.3 | 0.07 | 0.19 | 10 | SB | PE/PP | 0.5 | 20 | 5 | 12 | 27 |
| Example 56 | Melt ES | PP | 0.3 | 0.07 | 0.19 | 10 | SB | PE/PP | 0.5 | 20 | 5 | 12 | 27 |
| Example 57 | Melt ES | PP | 0.3 | 0.07 | 0.19 | 10 | SB | PE/PP | 0.5 | 20 | 5 | 12 | 27 |
| Example 58 | Melt ES | PP | 0.3 | 0.07 | 0.19 | 10 | SB | PE/PP | 0.5 | 20 | 5 | 12 | 27 |
| Example 59 | Melt ES | PP | 0.3 | 0.07 | 0.19 | 10 | SB | PE/PP | 0.5 | 20 | 5 | 12 | 27 |
| Example 60 | Melt ES | PP | 0.3 | 0.07 | 0.19 | 10 | SB | PE/PP | 0.5 | 20 | 5 | 12 | 27 |
| Example 61 | Melt ES | PP | 0.3 | 0.07 | 0.19 | 10 | SB | PE/PP | 0.5 | 20 | 5 | 12 | 27 |
| Comparative | a three layered fine pore film having a thickness of 32 μm produced by dry uniaxial stretching PE | | | | | | | | | | | | |
| Example 1 | sandwiched between two layers of PP | | | | | | | | | | | | |
| Comparative | a fine pore film having a thickness of 25 μm produced by dry uniaxial stretching PP | | | | | | | | | | | | |
| Example 2 | | | | | | | | | | | | | |
| Comparative | MB | PP | 2 | 0.1 | 0.7 | 20 | — | — | — | — | — | — | — |
| Example 3 | | | | | | | | | | | | | |
| Comparative | MB | PP | 2 | 0.1 | 0.7 | 54 | — | — | — | — | — | — | — |
| Example 4 | | | | | | | | | | | | | |
| Comparative | — | — | — | — | — | — | SB | PP | 0 | 30 | 7 | 17 | 83 |
| Example 5 | | | | | | | | | | | | | |
| Comparative | — | — | — | — | — | — | SB | PP | 0 | 30 | 7 | 17 | 62 |
| Example 6 | | | | | | | | | | | | | |
| Comparative | — | — | — | — | — | — | SB | PP | 0 | 30 | 7 | 17 | 100 |
| Example 7 | | | | | | | | | | | | | |
| Comparative | — | — | — | — | — | — | SB | PE/PP | 0.5 | 30 | 7 | 17 | 100 |
| Example 8 | | | | | | | | | | | | | |
| Comparative | Melt ES | PP | 0.3 | 0.07 | 0.19 | 20 | — | — | — | — | — | — | — |
| Example 9 | | | | | | | | | | | | | |
| Comparative | Melt ES | PP | 0.3 | 0.07 | 0.19 | 15 | — | — | — | — | — | — | — |
| Example 10 | | | | | | | | | | | | | |
| Comparative | Melt ES | PP | 0.3 | 0.7 | 0.19 | 10 | — | — | — | — | — | — | — |
| Example 11 | | | | | | | | | | | | | |
| Comparative | — | — | — | — | — | — | | PET | 0 | 27 | 0 | 15 | 100 |
| Example 12 | | | | | | | | | | | | | |
| Comparative | ES | PET | 0.4 | 0.1 | 0.31 | 30 | — | — | — | — | — | — | — |
| Example 13 | | | | | | | | | | | | | |
| Comparative | — | — | — | — | — | — | MB | m-AR | 0 | 15 | 3 | 10 | 60 |
| Example 14 | | | | | | | | | | | | | |
| Comparative | ES | m-AR | 0.4 | 0.1 | 0.31 | 25 | — | — | — | — | — | — | — |
| Example 15 | | | | | | | | | | | | | |
| Comparative | ES | PET | 0.4 | 0.1 | 0.31 | 23 | SB | PE/PP | 0.5 | 20 | 5 | 12 | 27 |
| Example 16 | | | | | | | | | | | | | |
| Comparative | ES | PVA | 0.3 | 0.08 | 0.2 | 20 | SB | PE/PP | 0.5 | 20 | 5 | 12 | 27 |
| Example 17 | | | | | | | | | | | | | |

| | |
|---|---|
| Laminate | Anodes |

| | | | | Rate of | | | Surface | Cathodes AL | | | Intial | 50 |
|---|---|---|---|---|---|---|---|---|---|---|---|---|
| | | | | formed | | | rough- | | Cost | Defec- | energy | cycle |
| | Thick- | Compres- | | into | Cathodes | Mater- | ness | | thick- | tion | density | retaining |
| | ness | sion | Fixed | plate | Material | ial | max. | Purity | ness | rate | mWh/ | rate |
| | μm | degree | or not | % | type | type | volume | % | nm | % | cc | % |
| Example 42 | 18 | 0.5 | fixed | 23 | LCO | AG | 18 | 99.3 | 10 | 0 | 20.0 | 67.8 |
| Example 43 | 19 | 0.5 | fixed | 23 | LCO + NMC | AG | 18 | 99.3 | 10 | 0 | 22.0 | 73.4 |
| Example 44 | 19 | 0.5 | fixed | 23 | LMO + LCO | AG | 18 | 99.3 | 10 | 0 | 18.0 | 69.6 |
| Example 45 | 19 | 0.5 | fixed | 23 | NGA + NMC | AG | 18 | 99.3 | 10 | 0 | 23.1 | 74.4 |
| Example 46 | 19 | 0.5 | fixed | 23 | NMC | AG | 100 | 99.3 | 10 | 10 | 21.4 | 65.9 |
| Example 47 | 19 | 0.5 | fixed | 23 | NMC | AG | 70 | 99.3 | 10 | 0 | 21.8 | 68.7 |
| Example 48 | 19 | 0.5 | fixed | 23 | NMC | AG | 42 | 99.3 | 10 | 0 | 22.2 | 75.3 |
| Example 49 | 19 | 0.5 | fixed | 23 | NMC | AG | 34 | 99.3 | 10 | 0 | 22.5 | 77.1 |
| Example 50 | 19 | 0.5 | fixed | 23 | NMC | AG | 25 | 99.3 | 10 | 0 | 22.8 | 78.1 |
| Example 51 | 19 | 0.5 | fixed | 23 | NMC | AG | 11 | 99.3 | 10 | 0 | 23.1 | 79.1 |
| Example 52 | 19 | 0.5 | fixed | 23 | NMC | AG | 5 | 99.3 | 10 | 0 | 23.6 | 74.8 |
| Example 53 | 19 | 0.5 | fixed | 23 | NMC | AG | 2 | 99.3 | 10 | 0 | 22.2 | 51.8 |
| Example 54 | 19 | 0.5 | fixed | 23 | NMC | AG | 18 | 93.8 | 10 | 0 | 23.1 | 79.1 |
| Example 55 | 19 | 0.5 | fixed | 23 | NMC | AG | 18 | 95.0 | 10 | 0 | 23.1 | 76.2 |
| Example 56 | 19 | 0.5 | fixed | 23 | NMC | AG | 18 | 98.0 | 10 | 0 | 23.1 | 74.4 |
| Example 57 | 19 | 0.5 | fixed | 23 | NMC | AG | 18 | 99.3 | 0.1 | 0 | 23.1 | 78.1 |
| Example 58 | 19 | 0.5 | fixed | 23 | NMC | AG | 18 | 99.3 | 0.5 | 0 | 23.1 | 78.1 |
| Example 59 | 19 | 0.5 | fixed | 23 | NMC | AG | 18 | 99.3 | 4 | 0 | 23.1 | 75.3 |
| Example 60 | 19 | 0.5 | fixed | 23 | NMC | AG | 16 | 99.3 | 17 | 0 | 23.1 | 66.8 |
| Example 61 | 19 | 0.5 | fixed | 23 | NMC | AG | 16 | 99.3 | 39 | 0 | 23.1 | 61.2 |
| Comparative | | | | | NMC | AG | 18 | 99.3 | 10 | 0 | 22.2 | 0 |
| Example 1 | | | | | | | | | | | | |
| Comparative | | | | | NMC | AG | 18 | 99.3 | 10 | 0 | 22.2 | 0 |
| Example 2 | | | | | | | | | | | | |
| Comparative | — | — | — | — | NMC | AG | 18 | 99.3 | 10 | 100 | — | — |
| Example 3 | | | | | | | | | | | | |
| Comparative | — | — | — | — | NMC | AG | 18 | 99.3 | 10 | 50 | 18.9 | 42.4 |
| Example 4 | | | | | | | | | | | | |
| Comparative | — | — | — | — | NMC | AG | 18 | 99.3 | 10 | 80 | 20.6 | 30.0 |
| Example 5 | | | | | | | | | | | | |
| Comparative | — | — | — | — | NMC | AG | 18 | 99.3 | 10 | 20 | 18.1 | 56.5 |
| Example 6 | | | | | | | | | | | | |
| Comparative | — | — | — | — | NMC | AG | 18 | 99.3 | 10 | 0 | 15.3 | 53.7 |
| Example 7 | | | | | | | | | | | | |
| Comparative | 60 | 0.6 | fixed | 60 | NMC | AG | 18 | 99.3 | 10 | 0 | 18.3 | 37.7 |
| Example 8 | | | | | | | | | | | | |
| Comparative | — | — | — | — | NMC | AG | 18 | 99.3 | 10 | 10 | 22.8 | 65.9 |
| Example 9 | | | | | | | | | | | | |
| Comparative | — | — | — | — | NMC | AG | 18 | 99.3 | 10 | 30 | 23.6 | 66.1 |
| Example 10 | | | | | | | | | | | | |
| Comparative | — | — | — | — | NMC | AG | 18 | 99.3 | 10 | 100 | — | — |
| Example 11 | | | | | | | | | | | | |
| Comparative | — | — | — | — | NMC | AG | 18 | 99.3 | 10 | 5 | 15.3 | 47.1 |
| Example 12 | | | | | | | | | | | | |
| Comparative | — | — | — | — | NMC | AG | 18 | 99.3 | 10 | 30 | 21.5 | 51.8 |
| Example 13 | | | | | | | | | | | | |
| Comparative | — | — | — | — | NMC | AG | 18 | 99.3 | 10 | 5 | 18.3 | 56.5 |
| Example 14 | | | | | | | | | | | | |
| Comparative | — | — | — | — | NMC | AG | 18 | 99.3 | 10 | 40 | 22.2 | 57.1 |
| Example 15 | | | | | | | | | | | | |
| Comparative | 30 | 0.6 | fixed | 45 | NMC | AG | 18 | 99.3 | 10 | 5 | 21.5 | 58.4 |
| Example 16 | | | | | | | | | | | | |
| Comparative | 28 | 0.6 | fixed | 25 | NMC | AG | 18 | 99.3 | 10 | 5 | 21.7 | 65.9 |
| Example 17 | | | | | | | | | | | | |

### DESCRIPTION OF NUMERALS

1-1 to 1-6: anode

2-1 to 2-10: separator

3-1 to 3-5: cathode

1. An organic electrolyte battery comprising:
cathodes;
anodes;
insulating sheets comprising a resin having no oxygen-containing group electrically insulating the cathodes and the anodes from each other; and
an organic electrolyte containing reactive ionic species, wherein
the insulating sheets are each a laminate of an assembly of one or both of nanoscale filaments and microscale filaments,
the nanoscale filaments having an average diameter of less than 1000 nm and the microscale filaments having an average diameter of 1 μm or more, and
the laminate containing portions where the nanoscale filaments and the microscale filaments are fused to each other or are formed into a plate shape by compression.

2. The organic electrolyte battery according to claim 1 wherein the average diameter of the nanoscale filaments is from 100 to 900 nm and the average diameter of the microscale filaments is from 2 to 50 μm.

3. (canceled)

4. The organic electrolyte battery according to claim 1 wherein the nanoscale filaments and the microscale filaments are filaments of thermoplastic resin.

5. The organic electrolyte battery according to claim 1 wherein the laminate is formed by compressing the nanoscale filaments and the microscale filaments while they are heated.

6. (canceled)

7. The organic electrolyte battery according to claim 1 wherein the rate of the portions of the laminate formed into a plate shape is 65% or less of a whole area of the laminate.

8. The organic electrolyte battery according to claim 1 wherein a compression degree of the laminate is from 0.1 to 0.65.

9. The organic electrolyte battery according to claim 4 wherein the laminate is formed of filaments of two or more thermoplastic resins each having different melting point.

10. The organic electrolyte battery according to claim 9 wherein a weight ratio of the thermoplastic resin having a lower melting point to the two or more thermoplastic resins is from 0.2 to 0.6.

11. The organic electrolyte battery according to claim 4 wherein the thermoplastic resin is a polyolefin.

12. The organic electrolyte battery according to claim 1 wherein the microscale filament is a filament with a core-in-sheath structure wherein the sheath is a low melting point resin.

13.-16. (canceled)

19. A laminate of filaments comprising nanoscale filaments having an average diameter of less than 1000 nm and microscale filaments having an average diameter of 1 μm or more, wherein the laminate contains portions where the nanoscale filaments and microscale filaments are fused to each other or are formed into a plate shape by compression.

20. The laminate according to claim 19 wherein an average diameter of the nanoscale filaments is from 100 to 900 nm and an average diameter of the microscale filaments is from 2 to 50 μm.

21. The laminate according to claim 19 wherein the nanoscale filaments and the microscale filaments are filaments of thermoplastic resin.

22. The laminate according to claim 19 wherein the laminate is formed by compressing the nanoscale filaments and the microscale filaments while they are heated.

23. The laminate according to claim 19 wherein the rate of the portions formed into a plate shape is 65% or less of a whole area of the laminate.

24. The laminate according to claim 19 wherein the compression degree is from 0.1 to 0.65.

25. The laminate according to claim 21 wherein the laminate is formed of filaments of two or more thermoplastic resins, each having a different melting point.

26. The laminate according to claim 25 wherein a weight ratio of a thermoplastic resin filament having a lower melting point to the two or more thermoplastic resins is from 0.2 to 0.6.

27. The laminate according to claim 21 wherein the thermoplastic resin is a polyolefin.

28. The laminate according to claim 19 wherein the microscale filament is a filament with a core-in-sheath structure wherein the sheath is a low melting point resin.
